(19) United States
(12) Patent Application Publication
(10) Pub. No.: US 2025/0076823 A1
(43) Pub. Date: Mar. 6, 2025

(54) WRISTWATCH AND WRISTWATCH-TYPE DISPLAY DEVICE

(71) Applicants: NAOTO FUKASAWA DESIGN LTD., Tokyo (JP); tha ltd., Tokyo (JP)

(72) Inventors: Naoto FUKASAWA, Tokyo (JP); Yugo NAKAMURA, Tokyo (JP)

(21) Appl. No.: 18/250,981

(22) PCT Filed: Oct. 25, 2021
(86) PCT No.: PCT/JP2021/039217

§ 371 Date: Dec. 17, 2023

(30) Foreign Application Priority Data
Nov. 4, 2020 (JP) 2020-184729

(51) Int. Cl. G04G 9/04; G04G 9/00; G04G 21/08; G09F 9/33; G09F 21/02

(52) U.S. Cl. CPC G04G 9/04; G04G 9/007; G04G 21/08; G09F 9/33; G09F 21/026

(57) ABSTRACT

A wristwatch according to the present invention includes: a wristwatch body having a rectangular parallelepiped shape; five display units that are formed over respective entire areas of five faces excluding a lower face out of six faces that form a surface of the wristwatch body; and a display control unit configured to control a display of each of five display units. The display control unit may have a function of controlling display on each of five display units such that respective images displayed on five display units are moved in a linked manner or are associated with each other. According to the present invention, it is possible to provide a wristwatch having a new value not obtained by the prior art.

### TECHNICAL FIELD

### Related Applications

The present application is a National Phase of International Application No. PCT/JP2021/039217 filed Oct. 25, 2021, which claims priority to Japanese Application No. 2020-184729 filed Nov. 4, 2020.

The present invention relates to a wristwatch and a wristwatch type display device.

### Background Art

Conventionally, there has been known a wristwatch having a new value not obtained in the prior art (see patent literatures 1 and 2, for example). FIG. 33 is a view provided for illustrating a conventional wristwatch 900. The wristwatch illustrated in FIG. 33 is a wristwatch illustrated in FIG. 13 in patent literature 2. In FIG. 33, the figure on the left is a perspective view of the wristwatch 900 during a display time, and the figure on the right is a perspective view of the wristwatch 900 during a non-display time. As illustrated in FIG. 33, the wristwatch 900 does not display anything let alone time during the no-display time. Accordingly, although the wristwatch 900 is a wristwatch, the wristwatch 900 having such a design makes a user not conscious of a time display function during the non-display time. Accordingly, such a wristwatch provides a new value not obtained by the prior art.

### CITATION LIST

### Patent Literature

PTL 1: Japanese registered design publication 1158328
PTL 2: Japanese Laid-open publication 2007-206577

### SUMMARY OF INVENTION

### Technical Problem

However, in our human society, a new era requires an advent of a product having a new value. The field of the wristwatch is no exception.

The present invention has been made in view of the above-mentioned circumstances, and it is an object of the present invention to provide a wristwatch and a wristwatch type display device having a new value not obtained by the prior art.

### Solution to Problem

According to an aspect of the present invention, there is provided a wristwatch that includes: a wristwatch body having a rectangular parallelepiped shape; at least two display units that are formed over respective entire areas of “an upper face on a side opposite to a lower face directed toward a side of an arm of a user at a time of using the wristwatch” and “at least one side face out of four side faces” out of six faces that form a surface of the wristwatch body; and a display control unit configured to control a display of each of the at least two display units.

In the wristwatch according to the present invention, it is preferable that the display control unit have a function of controlling display on each of the at least two display units such that images displayed on the respective at least two display units are moved in a linked manner or are associated (related) with each other.

In the configuration, “are moved in a linked manner” includes a case where the images displayed on the at least two display units move in a seamless manner by straddling the at least two display units. Further, “are moved in a linked manner” includes a case where the at least two display units change a turn on/off state one after another based on a predetermined rule or at random. For example “are moved in a linked manner” includes a case where, with respect to the at least two display units, one display unit performs display in red and, thereafter, the other display unit performs display in the same color or in different color. In this case, the respective display units perform display sequentially and independently in accordance with a predetermined rule.

In the wristwatch according to the present invention, it is preferable that at least two display units include: five display units that are formed over the respective entire areas of five faces that are formed of the upper face and the four side faces.

In the wristwatch according to the present invention, it is preferable that in a state where the five faces of the wristwatch body display no pattern on the five display units, no pattern be displayed over the entire areas of five respective display units.

In the wristwatch according to the present invention, it is preferable that the five display units be formed of five organic EL display sheets or five micro LED display sheets, and the five organic EL display sheets or the micro LED display sheets be attached to the five faces of the wristwatch body respectively.

In the wristwatch according to the present invention, it is preferable that the five display units be formed of one organic EL display sheet or one micro LED display sheet, and the one organic EL display sheet or one sheet of micro LED display sheet be bent along an outer shape of the wristwatch body and is attached (laminated) to the wristwatch body.

In the wristwatch according to the present invention, it is preferable that a first electrode group for supplying power and electric signals to the organic EL display sheet or the micro LED display sheet be mounted on the five faces of the wristwatch body, and a second electrode group for receiving the power and the electric signals from the first electrode group be mounted on a back face of the organic EL display sheet or the micro LED display sheet at a position that corresponds to the first electrode group, and the wristwatch include a drive circuit that supplies an electric signal for controlling a turn on/off states of the respective pixels of the organic EL display sheet or the micro LED display sheet, and the first electrode group and the second electrode group be electrically connected to each other.

In the wristwatch according to the present invention, it is preferable that a gap formed between five display units be embedded with a black member so as to prevent the gap from being visually recognized from the outside.

In the wristwatch according to the present invention, it is preferable that a protective member be applied to by coating to five display units so as to cover the entirety of five display units and be cured.

In the wristwatch according to the present invention, it is preferable that, assuming the display unit formed on an upper face of the wristwatch body on a side opposite to a lower face of the wristwatch body as an upper face display unit and the display units formed on four side faces of the wristwatch body as four side face display units with respect to the five display units, in a case where a display mode on the five display units is an analog watch display mode where a time is displayed by a plurality of hands, the display control unit control the respective displays of the five display units such that at least the longest hand out of the plurality of hands extends from the upper face display unit to at least one side face display unit out of the four side face display units, and a portion of the hand that extends over the one side face display unit that is displayed on the upper face display unit and a portion of the hand that extends over the first side face display unit that is displayed on the one side face display unit rotate in a linked manner.

In the wristwatch according to the present invention, it is preferable that, assuming the display unit formed on an upper face of the wristwatch body on a side opposite to a lower face of the wristwatch body as an upper face display unit and display units formed on four side faces of the wristwatch body as four side face display units with respect to the five display units, and assuming the side face display unit positioned on a depth side as viewed from a user at a time of using the wristwatch as a first side face display unit, the side face display unit positioned on a back side of a hand as a second side face display unit, the side face display unit disposed on a side opposite to the first side face display unit as a third side face display unit, and the side face display unit disposed on a side opposite to the second side face display unit as a fourth side face display unit with respect to the four side face display units, in a case where a display mode in the five display units is in an analogue watch display mode where time is indicated by a plurality of hands, the display control unit control the respective displays of the five display units as if the inside of the wristwatch body is viewed in a see-through manner as viewed from the user, and a display of numerical values that indicates a time in the analogue watch display mode is performed in a left-and-right normal display on at least the third side face display unit, and is performed in a reverse left-and-right display in at least the first side face display unit.

In the wristwatch according to the present invention, it is preferable that, in a case where a display mode in the five display units is in an analogue watch display mode where time is indicated by a plurality of hands, the display control unit control the respective displays of the five display units as if the inside of the wristwatch body is viewed in a see-through manner as viewed from the user at a time of using the wristwatch, and the plurality of hands rotate in a state where the plurality of hands are positioned in the wristwatch body.

In the wristwatch according to the present invention, it is preferable that the display control unit control the respective displays of the five display units as if the inside of the wristwatch body is viewed in a see-through manner as viewed from a user.

In the wristwatch according to the present invention, it is preferable that assuming the display unit formed on an upper face opposite to a lower face of the wristwatch body as an upper face display unit with respect to the five display units and display units formed on four side faces of the wristwatch body as four side face display units, in a case where the display mode adopted by the five display units is a digital watch display mode where a time is displayed as a combination of a plurality of numerals, the display control unit performs a control where at least a portion of the plurality of numerals extends from the upper face display unit over the four side face display units or a portion that has been extended once returns to the upper face display unit.

In the wristwatch according to the present invention, it is preferable that the five display units be formed of a touch panel.

In the wristwatch according to the present invention, it is preferable that the display control unit control the respective displays of the five display units such that an image is changed over corresponding to a swipe operation performed by a finger of the user on the touch panel.

A wristwatch type display device according to the present invention includes: a wristwatch type display device body having a rectangular parallelepiped shape; at least two display units that are formed over respective entire areas of “an upper face on a side opposite to a lower face directed to an arm side of a user at a time of using the wristwatch type display device” and “at least one side face out of four side faces” out of six faces that form a surface of the wristwatch type display device body; and a display control unit that controls the respective displays of the at least two display units.

In the wristwatch type display device according to the present invention, it is preferable that the display control unit have a function of controlling display on each of the at least two display units such that images displayed on the respective at least two display units are moved in a linked manner or are associated with each other.

In the wristwatch type display device according to the present invention, it is preferable that the at least two display units be formed of five display units that are formed over the respective entire areas of five faces formed of the upper face and the four side faces.

Also in the wristwatch type display device according to the present invention, it is preferable that the wristwatch type display device have the respective technical features that the wristwatch has.

### Advantageous Effects of Invention

According to the wristwatch of the present invention and the wristwatch type display device of the present invention, as can be also understood from the embodiments described later, various types of images can be displayed in various modes by also making use of the side faces in addition to the upper face of the wristwatch body having a rectangular parallelepiped shape. In this manner, according to the wristwatch of the present invention and the wristwatch type display device of the present invention, it is possible to provide the wristwatch and the wristwatch type display device having new value not obtained by the prior art.

### BRIEF DESCRIPTION OF DRAWINGS

FIG. 1 is a view illustrating a state where a user wears a wristwatch 1 according to an embodiment on his/her left arm.

FIG. 2A and FIG. 2B are views illustrating, in an enlarged manner, the wristwatch 1 that the user wears on his/her arm as illustrated in FIG. 1.

FIG. 3 is a view for describing a wristwatch body 100 of the wristwatch 1 and display units 200 formed on five faces of the wristwatch body 100 excluding a lower face of the wristwatch body 100 according to the embodiment.

FIG. 4 is a view that is a functional block diagram of the configuration of a control system for operating the wristwatch 1 according to the embodiment.

FIG. 5 is a view for describing a treatment applied to a gap formed between organic EL display sheets disposed adjacently to each other.

FIG. 6 is a view describing a state where a protective member 290 is applied by coating so as to cover the entire wristwatch 1 and the protective member 290 is cured.

FIG. 7 is a view for describing a modification 1 of a first display mode.

FIG. 8 is a view for describing a second display mode of the wristwatch 1 according to the embodiment.

FIG. 9 is a view for describing a third display mode of the wristwatch 1 according to the embodiment.

FIG. 10 is a view for describing a fourth display mode of the wristwatch 1 according to the embodiment.

FIG. 11A and FIG. 11B are views for describing a fifth display mode of the wristwatch 1 according to the embodiment.

FIG. 12A and FIG. 12B are views for describing a sixth display mode of the wristwatch 1 according to the embodiment.

FIG. 13 is a view for describing a seventh display mode of the wristwatch 1 according to the embodiment.

FIG. 14 is a view for describing an eighth display mode of the wristwatch 1 according to the embodiment.

FIG. 15 is a view for describing a ninth display mode of the wristwatch 1 according to the embodiment.

FIG. 16 is a view for describing a case where five display units 210 to 214 are formed using a single organic EL display sheet.

FIG. 17 is a view describing a case where a user sees the wristwatch 1 by further bending his/her arm in the second display mode of the wristwatch 1 according to the embodiment.

FIG. 18 is a view for describing another display mode (tenth display mode) of the wristwatch 1 according to the embodiment.

FIG. 19 is a view for describing another display mode (eleventh display mode) of the wristwatch 1 according to the embodiment.

FIG. 20 is a view for describing another display mode (twelfth display mode) of the wristwatch 1 according to the embodiment.

FIG. 21 is a view for describing another display mode (thirteenth display mode) of the wristwatch 1 according to the embodiment.

FIG. 22 is a view for describing another display mode (fourteenth display mode) of the wristwatch 1 according to the embodiment.

FIG. 23 is a view for describing another display mode (fifteenth display mode) of the wristwatch 1 according to the embodiment.

FIG. 24 is a view for describing another display mode (sixteenth display mode) of the wristwatch 1 according to the embodiment.

FIG. 25 is a view for describing another display mode (sixteenth display mode) of the wristwatch 1 according to the embodiment.

FIG. 26 is a view for describing another display mode (seventeenth display mode) of the wristwatch 1 according to the embodiment.

FIG. 27 is a view for describing another display mode (eighteenth display mode) of the wristwatch 1 according to the embodiment.

FIG. 28 is a view for describing another display mode (nineteenth display mode) of the wristwatch 1 according to the embodiment.

FIG. 29 is a view for describing another display mode (twentieth display mode) of the wristwatch 1 according to the embodiment.

FIG. 30 is a view for describing another display mode (twentieth display mode) of the wristwatch 1 according to the embodiment.

FIG. 31 is a view for illustrating a case where five display units 210 to 214 are formed using three organic EL sheets.

FIG. 32A to FIG. 32I are views for illustrating a case where the display unit 200 is formed using at least two display units.

FIG. 33 is a view illustrating the wristwatch 900 of the prior art.

### DESCRIPTION OF EMBODIMENTS

Hereinafter, the respective embodiments of the present invention are described.

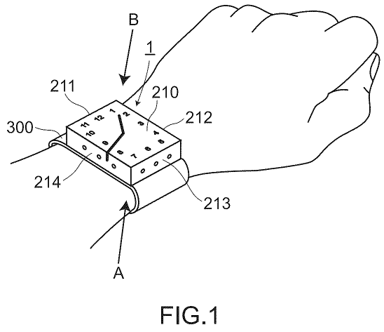

FIG. 1 is a view illustrating a state where a user wears a wristwatch 1 according to an embodiment on his/her left hand of a user. In FIG. 1, an arrow A indicates the direction of the field of vision when the user sees the wristwatch mounted on the wrist of the left hand. That is, in a case where the user sees the wristwatch 1 mounted on the wrist of the left hand, in general, the user watches the wristwatch 1 in a posture where the user slightly bends his/her elbow toward his/her body (side or chest). FIG. 1 illustrates the direction of the field of view in such a state. In FIG. 1, the arrow A is drawn as a direction on a horizontal plane. However, in general, the direction of the actual field of view is directed in an oblique downward direction from eyes of the user.

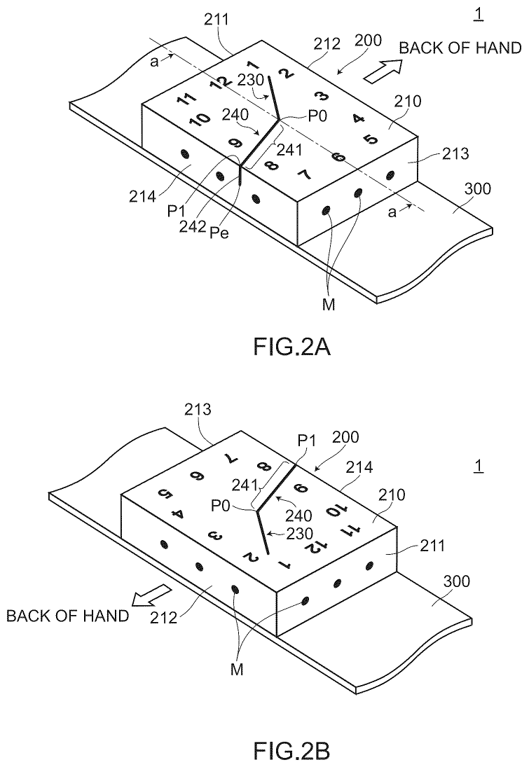

FIG. 2A and FIG. 2B are views illustrating the wristwatch 1 that the user wears on his/her arm as illustrated in FIG. 1 in an enlarged manner. FIG. 2A is an enlarged view of a case where the user sees the wristwatch 1 that the user wears on his/her arm along a direction indicated by an arrow A, and FIG. 2B is an enlarged view of a case where the user sees the wristwatch 1 that the user wears on his/her arm along a direction indicated by an arrow B (the direction opposite to the direction A) in FIG. 1. FIG. 2A and FIG. 2B illustrate a state where a time display is performed in an analog watch display mode indicating a time by an hour hand and a minute hand. FIG. 2A and FIG. 2B are also views for describing a first display mode of the wristwatch 1 according to the embodiment. The first display mode is described later.

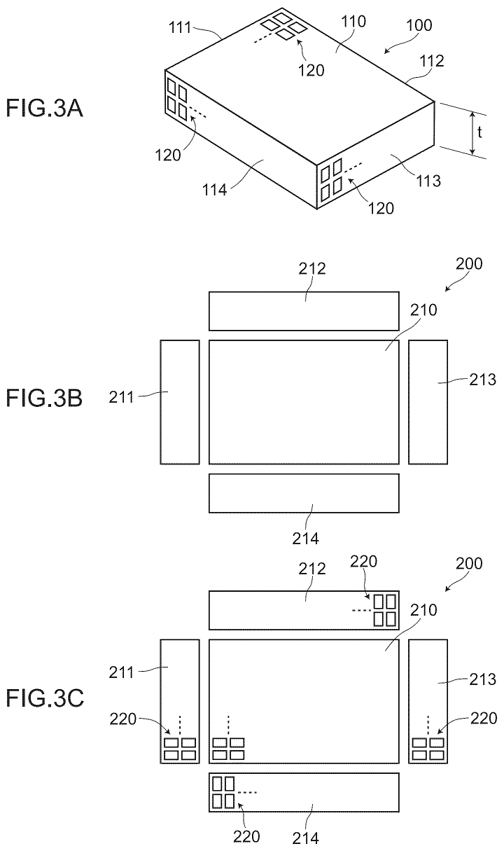

FIG. 3A to FIG. 3C are views for describing the wristwatch body 100 of the wristwatch 1 and display units 200 formed on five faces of the wristwatch body 100 excluding a lower face of the wristwatch body 100 according to the embodiment. FIG. 3A is a perspective view of the wristwatch body 100, and FIG. 3B is a plan view of the display unit 200 of the wristwatch 1 in a state where the display unit 200 is developed into five display units 210 to 214.

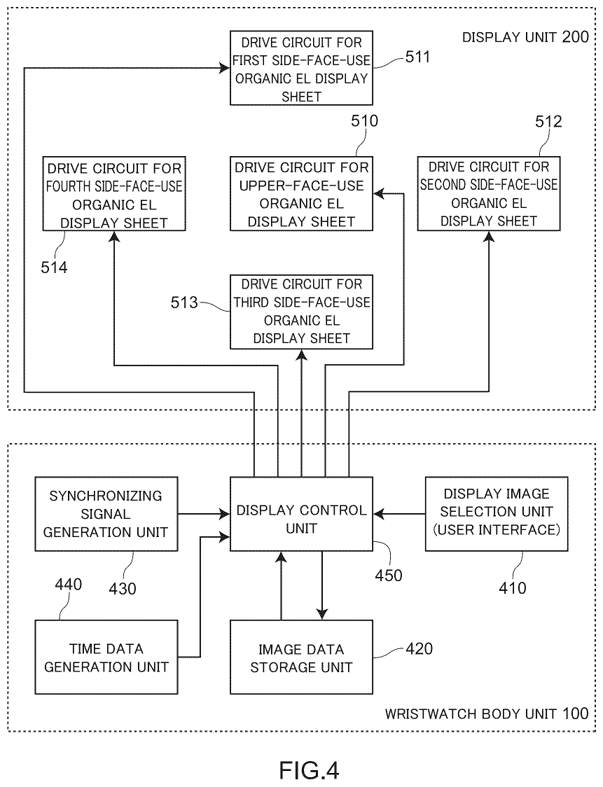

The configuration of the wristwatch 1 according to the embodiment is described with reference to FIG. 1, FIG. 2A, FIG. 2B and FIG. 3A to FIG. 3C. The wristwatch 1 according to the embodiment includes: the wristwatch body 100 having a rectangular parallelepiped shape; five display units 210 to 214 that are formed over respective entire areas of five faces (an upper face and four side faces) excluding a lower face directed toward a side of an arm of the user at a time of using the wristwatch 1; a belt 300 for allowing the user to wear the wristwatch 1 on his/her hand; and a display control unit 450 configured to control a display of each of five display units 210 to 214 (the display control unit 450 being described later using FIG. 4). In the present invention, “formed over the entire areas” is satisfied so long as the display unit is formed over the entire area of the face as viewed from the user. The display unit may not be formed over the entire area of the face in a strict meaning of the wording.

As illustrated in FIG. 3A, the wristwatch body 100 formed into a rectangular parallelepiped shape having a predetermined thickness t. As illustrated in FIG. 2A and FIG. 2B, five display units 210 to 214 are formed on five faces consisting of an upper face 110 on a side opposite to a lower face and four side faces (the first side face 111, the second side face 112, the third side face 113, and the fourth side face 114). With respect to five display units 210 to 214, assume the display unit formed on the upper face 110 of the wristwatch body 100 as the upper face display unit 210, the display unit formed on the first side face 111 of the wristwatch body 100 as the first side face display unit 211, the display unit formed on the second side face 112 of the wristwatch body 100 as the second side face display unit 212, the display unit formed on the third side face 113 of the wristwatch body 100 as the third side face display unit 213, and the display unit formed on the fourth side face 114 of the wristwatch body 100 as the fourth side face display unit 214.

Five display units 210 to 214 are formed of five organic electroluminescence (EL) display sheets. That is, the upper display unit 210 is formed of an upper-face-use organic EL display sheet, the first display unit 211 is formed of a first-side-face-use organic EL display sheet, the second side face display unit 212 is formed of a second-side-face-use organic EL display sheet, the third side face display unit 213 is formed of a third-side-face-use organic EL display sheet, and the fourth side face display unit 214 is formed of a fourth-side-face-use organic EL display sheet.

In the description made hereinafter, in a case where five display units 210 to 214 are described as the organic EL display sheets that respectively correspond to five display units 210 to 214, the respective organic EL display sheets are indicated by using the same symbols used for indicating five display units 210 to 214. That is, the respective display units are described as the upper-face-use organic EL display sheet 210, the first-side-face-use organic EL display sheet 211, the second-side-face-use organic EL display sheet 212, the third-side-face-use organic EL display sheet 213, and the fourth-side-face-use organic EL display sheet 214.

For collectively describing the upper-face-use organic EL display sheet 210, the first-side-face-use organic EL display sheet 211, the second-side-face-use organic EL display sheet 212, the third-side-face-use organic EL display sheet 213, and the fourth-side-face-use organic EL display sheet 214, there may be a case where the expression “the respective organic EL display sheets 210 to 214” is used. Further, for collectively describing the first-side-face-use organic EL display sheet 211, the second-side-face-use organic EL display sheet 212, the third-side-face-use organic EL display sheet 213, and the fourth-side-face-use organic EL display sheet 214, there may be a case where the expression “the respective side-face organic EL display sheets 211 to 214” is used.

These respective organic EL display sheets 210 to 214 are attached to the upper face 110 and four side faces (the first side face 111, the second side face 112, the third side face 113, the fourth side face 114) of the wristwatch body 100 on a one-to-one basis. With such an operation, the wristwatch 1 illustrated in FIG. 1, FIG. 2A and FIG. 2B are formed. In FIG. 1, FIG. 2A and FIG. 2B, a state is illustrated ere an analogue time display is performed. In a case where no display is performed, no pattern appears over the entire areas of the display unit 200. In this specification, “no pattern” means that neither an analog watch display nor a digital watch display is performed.

In this case, the display unit 200 is formed by laminating five organic EL display sheets (the respective organic EL display sheets 210 to 214) to the wristwatch body 100 on a one-to-one basis. With such a configuration, corner portions of the wristwatch 1 (angle portions formed between the upper-face-use organic EL display sheet 210 and the respective side-face-use organic EL display sheets 211 to 214) can be set at a right angle, and flatness of each of the respective organic EL display sheets 210 to 214 can be increased and hence, the wristwatch 1 becomes simple in appearance.

A first electrode group 120 for supplying power and electric signals to the respective organic EL display sheets 210 to 214 is mounted on five faces of the wristwatch body 100, that is, the upper face 110 and four side faces (the first side face 111, the second side face 112, the third side face 113, and the fourth side face 114) in an exposed manner. On the other hand, a second electrode group 220 that receive the power and the electric signals from the first electrode group 120 are mounted on respective back surfaces of the respective organic EL display sheets 210 to 214 at positions where the second electrode group 220 corresponds to the first electrode group 120. Between the first electrode group 120 mounted on the wristwatch body 100 and the second electrode group 220 mounted on the respective organic EL display sheets 210 to 214, the corresponding electrodes are electrically connected to each other. Further, a drive circuit for supplying electric signals so as to control a turn on/off state of respective pixels of the respective organic EL display sheets 210 to 214 is mounted on respective back surfaces of the respective organic EL display sheets 210 to 214. In FIG. 3A to FIG. 3C, the drive circuits are not illustrated.

FIG. 4 is a view that is a functional block diagram of the configuration of a control system for operating the wristwatch 1 according to the embodiment. In the functional block diagram illustrated in FIG. 4, among various functions that the wristwatch 1 according to the embodiment has, mainly, functional blocks that are necessary for performing a display are illustrated.

On the wristwatch body 100 side, the control system includes a display image selection unit 410, an image data storage unit 420, a synchronous signal generation unit 430, a time data generation unit 440, and the display control unit 450. The display image selection unit 410 is provided as a user interface that can select a kind of display to be performed by five display units 210 to 214 (the respective organic EL display sheets 210 to 214). The image data storage unit 420 is provided for storing images to be displayed on the respective organic EL display sheets 210 to 214. The synchronous signal generation unit 430 that generates a synchronous signal for acquiring synchronism between the respective organic EL display sheets 210 to 214 such that images that the respective organic EL display sheets 210 to 214 display become images that are moved in a linked manner or are associated with each other. The time data generation unit 440 generates present time data. The display control unit 450 controls the displays of the respective organic EL display sheets 210 to 214. Images that are displayed on the respective organic EL display sheets 210 to 214 may be, besides images stored in the image data storage unit 420, images generated by an image data generation unit not illustrated in the drawing, or may be images received from the outside via communication. Further, the images that are displayed on the respective organic EL display sheets 210 to 214 may be images transmitted from a smartphone of a user or images from a video screaming company under contract.

On the other hand, on the display unit 200 side, the control system includes a drive circuit 510 for the upper-face-use organic EL display sheet 210, a drive circuit 511 for the first-side-face-use organic EL display sheet 211, a drive circuit 512 for the second-side-face-use organic EL display sheet 212, a drive circuit 513 for the third-side-face-use organic EL display sheet 213, and a drive circuit 514 for the fourth-side-face-use organic EL display sheet 214.

Although not illustrated in FIG. 4, on the wristwatch body 100 side, the control system also includes a power source unit for supplying power to the respective functional blocks illustrated in FIG. 4. Power from the power source unit and various signals from the display control unit 450 and the like are supplied via the first electrode group 120 (see FIG. 3A) disposed on the wristwatch body 100 side and the second electrode group 220 (see FIG. 3C) disposed on the respective organic EL display sheets 210 to 214 side.

The display control unit 450 reads images stored in the image data storage unit 420 based on the content that a user selects from the display image selection unit 410, and performs a control of displaying the read images on the respective organic EL display sheets 210 to 214. In such processing, the display control unit 450 controls the displays of the respective organic EL display sheets 210 to 214 such that the images to be displayed on the respective organic EL display sheets 210 to 214 are moved in a linked manner or are associated with each other.

In this manner, the display control unit 450 performs a control of displaying the images read from the image data storage unit 420 on the respective organic EL display sheets 210 to 214. At the time of starting the wristwatch 1 according to the embodiment 1, the display control unit 450 performs a control of displaying a display image selection screen that functions as the display image selection unit 410. When the display image selection screen is displayed on the wristwatch 1, a user can select the content to be displayed from the displayed display image selection screen. Then, the display control unit 450 controls a display based on a display mode that the user has selected. The display image selection may be performed from a selection screen of a smartphone of the user associated with the wristwatch.

For example, when the user selects an analogue time display from the display image selection unit 410, five display units 210 to 214 of the wristwatch 1 according to the embodiment 1 are brought into an analogue time display mode. In this mode, the display control unit 450 reads the present time data from the time data generation unit 440 and, as illustrated in FIG. 2A and FIG. 2B, the display control unit 450 controls the respective drive circuits 510 to 514 of the respective organic EL display sheets 210 to 214 so as to enable the display of the present time by a hour hand and a minute hand on the respective organic EL display sheets 210 to 214. The selection of the display image may be performed using a selection screen of a smartphone of a user that is associated with the wristwatch.

As described previously with respect to FIG. 3A to FIG. 3C, respective organic EL display sheets 210 to 214 are laminated to five faces out of six faces that form the surface of the wristwatch body 100 respectively except for the lower face. That is, the upper-face-use organic EL display sheet 210 is laminated to the upper face 110 of the wristwatch body 100, the first side-face-use organic EL display sheet 210 is laminated to the first side face 111 of the wristwatch body 100, the second side-face-use organic EL display sheet 212 is laminated to the second side face 112 of the wristwatch body 100, the third side-face-use organic EL display sheet 213 is laminated to the third side face 113 of the wristwatch body 100, and the fourth side-face-use organic EL display sheet 214 is laminated to the fourth side face 114 of the wristwatch body 100. When the respective organic EL display sheets 210 to 214 are laminated to the respective corresponding faces of the wristwatch body 100, there may be a case where a gap that corresponds to a thickness of the organic EL display sheet is formed between the organic EL display sheets disposed adjacently to each other at the corner portions of the wristwatch body 100.

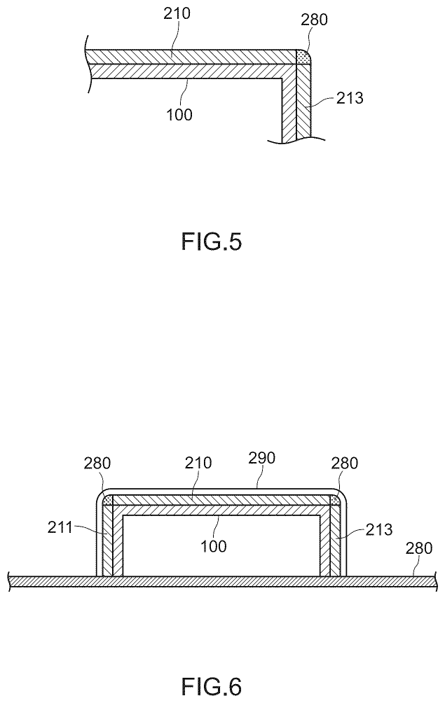

FIG. 5 is a view for describing a treatment applied to a gap formed between organic EL display sheets disposed adjacently to each other. FIG. 5 is a view illustrating an example where the gap is formed between the upper-face-use organic EL display sheet 210 and the third side-face-use organic EL display sheet 213.

As illustrated in FIG. 5, at the corner portion of the wristwatch body 100, a black member 280 is embedded between the organic EL display sheets disposed adjacently to each other (in this case, between the upper-face-use organic EL display sheet 210 and the third side-face-use organic EL display sheet 213). As the black member, for example, silicone rubber or the like having black as its color can be used. By embedding a black member 280 in the gap formed between the organic EL display sheets disposed adjacently to each other, the gap formed between the organic EL display sheets disposed adjacently to each other becomes inconspicuous and hence, an external appearance of the wristwatch 1 becomes simple thus providing favorable aesthetic impression in appearance to a viewer.

In FIG. 5, the case is described where the black member 280 is disposed between the upper-face-use organic EL display sheet 210 and the third side-face-use organic EL display sheet 213. However, the black member 280 is also filled between 5 display units 210 to 214, that is, between the first side-face-use organic EL display sheet 211 and the second side-face-use organic EL display sheet 212, between the second side-face-use organic EL display sheet 212 and the third side-face-use organic EL display sheet 213, between the third side-face-use organic EL display sheet 213 and the fourth side-face-use organic EL display sheet 214, between the fourth side-face-use organic EL display sheet 214 and the first side-face-use organic EL display sheet 211, and between the upper-face-use organic EL display sheet 210 and the respective side-face-use organic EL display sheets 211 to 214.

With such a configuration, a state is brought about where the black member 280 is embedded in a corner portion of the wristwatch body, that is, between the organic EL display sheets disposed adjacently to each other. A protective member 290 (see FIG. 6) is applied by coating on surfaces of the respective organic EL display sheets 210 to 214 in a state where the black member 280 is embedded between the organic EL display sheets disposed adjacently to each other such that the protective member 290 covers the entirety of the respective organic EL display sheets 210 to 214, and the protective member 290 is cured.

FIG. 6 is a view describing a state where a protective member 290 is applied by coating so as to cover the entire wristwatch 1 and the protective member 290 is cured. FIG. 6 is a cross-sectional view of FIG. 2A as viewed in a direction indicated by an arrow a-a. Constitutional components of such as the display control unit 450 disposed in the wristwatch body 100 (see the functional block diagram illustrated in FIG. 4) are omitted. As illustrated in FIG. 6, the transparent protective member 290 is applied by coating to the entirety of five display units of the wristwatch 1, that is, the upper-face-use organic EL display sheet 210 and the respective first side-face-use organic EL display sheets 211 to 214, and is cured.

In such a configuration, as the protective member 290, a silicone resin or the like having waterproof property, corrosion resistance property and heat resistance property can be preferably used. In this manner, the transparent protective member 290 is applied by coating to the entirety of five display units of the wristwatch 1, that is, the upper-face-use organic EL display sheet 210 and the respective first side-face-use organic EL display sheets 211 to 214, and is cured. Accordingly, the wristwatch 1 becomes a wristwatch that has waterproof property, corrosion resistance property and heat resistance property, and is minimally broken whereby it is possible to provide a wristwatch having high reliability.

Next, specific display modes of the wristwatch 1 according to the embodiment are described. A user to the can wear the wristwatch 1 according embodiment on either his/her left or right arm. In this embodiment, as illustrated in FIG. 1, the case is described where the user wears the wristwatch 1 according to the embodiment on his/her left arm.

### [First Display Mode]

The first display mode is described. Assume that the user selects an analog watch display from the display image selection unit 410. Accordingly, five display units 210 to 214 perform a display in an analog watch display mode where time is displayed by a plurality of hands, and the present time is displayed on five display units 210 to 214 of the wristwatch 1. In this case, as “a plurality of hands”, an hour hand, a minute hand and a second hand may be considered as an example. However, in the first display mode, the case is described where the time display is performed by the hour hand and the minute hand.

For example, as illustrated in FIG. 2A and FIG. 2B, assume that 1:43 is displayed as the present time. In the first display mode, an hour hand 230 points a position between numerical values “1” and “2” that indicate the time on the upper face display unit 210, and the minute and a minute hand 240 extends from the upper face display unit 210 over the fourth side face display unit 214. More specifically, although the hour hand is retained on the display on the upper face display unit 210, the minute hand 240 passes between “8” and “9” in the display unit 210, is bent at a corner portion P1 formed by the upper face display unit 210 and the fourth side face display unit 214, and extends to the fourth side face display unit 214.

In the above-mentioned configuration, the hand that displays the time by extending from the upper face display unit 210 to the fourth side face display unit 214 may be either the hour hand 230 or the minute hand 240. However, it is preferable that the time be displayed by extending the hand having a larger length from the upper face display unit 210 to the fourth side face display unit 214.

In that case where the length of the hour hand and the length of the minute hand are compared with each other, in general, the minute hand is longer than the hour hand. Accordingly, in the above-mentioned configuration, the minute hand is set as the hand that displays the time by extending the hand from the upper face display unit 210 to the fourth side face display unit 214.

In FIG. 2A and FIG. 2B, the numerical values “1” to “12” that indicate the time are displayed on the upper face display unit 210, and the hour hand 230 is displayed on the upper face display unit 210. Accordingly, the time in terms of the unit of hour can be intuitively known from the position of the hour hand 230. On the other hand, the minute hand 240 is displayed such that the minute hand 240 extends from the upper face display unit 210 to the fourth side face display unit 214. Accordingly, the time in terms of the unit of minute cannot be accurately grasped from a distal end portion Pe of the minute hand 240. To facilitate the understanding which position the distal end portion Pe of the minute hand 240 points, it is preferable to display certain marks (for example, round marks M) at positions that correspond to numerals from “1” to “12” displayed on the upper face display unit 210 (see FIG. 2A and FIG. 2B). By displaying such round marks M, the time in terms of the unit of minute at the present time can be easily read from the position that the distal end portion Pe of the minute hand 240 points.

The display control for displaying the hour hand 230 and the minute hand 240 is performed by the display control unit 450. That is, in the wristwatch 1 according to the embodiment, the control unit 450 controls the displays of five display units 210 to 214, that is, the respective organic EL display sheets 210 to 214 such that the minute hand 240 extends from the upper face unit 210 over one side face out of the respective side face display units 211 to 214, and the minute hand 241 displayed on the upper face display unit 210 and the minute hand 242 displayed on at least one side face out of four side faces are rotated in a linked manner.

In the specific display control of the minute hand 240 in this case, the drive circuit 510 of the upper face organic EL display sheet 210 and the drive circuit 514 of the fourth side face organic EL display sheet 214 are controlled based on a synchronizing signal from the synchronous signal generation unit 430 such that the minute hand 241 displayed on the upper face display unit 210, that is, the minute hand 241 displayed between a rotary shaft portion Po and the corner portion P1 (referred to as the upper face display minute hand 241) and the minute hand displayed in the fourth side face display unit 214, that is, the minute hand 242 displayed between the corner portion P1 and the distal end portion Pe of the minute hand 240 (referred as a side face display minute hand 242) are rotated in a linked manner. On the other hand, in a display control for displaying the hour hand 230, the drive circuit 510 of the upper-face-use organic EL display sheet 210 is driven such that the hour hand 230 rotates about the rotary shaft portion P0 on the upper face display unit 210.

In this embodiment, the case is described where the minute hand 240 is displayed on the fourth face display unit 214. As the time changes from moment to moment, the upper face display minute hand 241 is displayed so as to rotate in a so-called clockwise direction on the upper-face-use organic EL display sheet 210, and the side face display minute hand 242 is displayed so as to rotate in a so-called clockwise direction on the respective side face display units 211 to 214 in a linked manner with the upper face display minute hand 241.

The upper face display unit 210 formed on the wristwatch body 100 is not formed in a circular shape and hence, to display the minute hand 240 in an extending manner over the respective side face display units 211 to 214, it is necessary to make the length of the minute hand 240 (the length from the rotary shaft portion Po to the corner portion P1) different corresponding to the position of the minute hand 240. For example, it is necessary to perform a display control such that the length of the upper face display minute hand 241 differs between the case where the minute hand 240 is positioned at “9” on the fourth side face display unit 214 and the case where the minute hand 240 is positioned at “11” on the fourth side face display unit 214.

In such a display control, the length of the upper face display minute hand 241 is set corresponding to the position of the minute hand 240 in advance, and the display control unit 450 displays the upper face display minute hand 241 based on the length of the upper face display minute hand 241 set corresponding to the position of the minute hand 240. Since the display control unit 450 performs such a display control and hence, whichever position on the upper face display unit 210 the minute hand 240 is disposed, a distance from the rotary shaft portion Po to the distal end portion Pe can be displayed as the single minute hand.

In this manner, in the first display mode, not only the hour hand 230 and the minute hand 240 are displayed on the upper face display unit 210, but also the minute hand 240 is displayed in a state where the minute hand 240 extends from the upper face display unit 210 to one side face display unit out of the respective side face display units 211 to 214. Accordingly, the wristwatch 1 according to the embodiment 1 can perform the display in accordance with the first display mode and hence, the wristwatch 1 according to the embodiment 1 becomes a wristwatch having a new value not obtained in the prior art.

### [Modification 1 of First Display Mode]

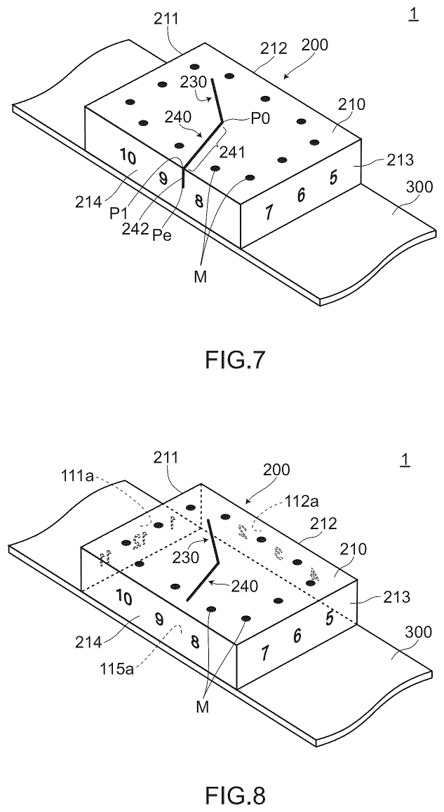

In the above-mentioned display mode, the case is exemplified where the numerals from “1” to “12” that indicate time are displayed on the upper face display unit 210. However, as illustrated in FIG. 7, the numerals from “1” to “12” may be displayed on the respective side face display units 211 to 214. That is, the display control unit 450 controls the drive circuits of the respective organic EL display sheets 211 to 214 such that “11”, “12” and “1” are displayed on the first side face display unit 211, “2”, “3” and “4” are displayed on the second side face display unit 212, “5”, “6” and “7” are displayed on the third side face display unit 213, and “8”, “9” and “10” are displayed on the fourth side face display unit 214. In this case, in the upper face display unit 210, it is preferable that round marks M be displayed at positions corresponding to the numerals “1” to “12” displayed on the respective side face display units 211 to 214.

Further, the hour hand 230 is displayed on the upper face display unit 210 in the same manner as the first display mode illustrated in FIG. 2A and FIG. 2B, and the minute hand 240 is displayed such that the minute hand 240 extends over one side face out of the respective side face display units 211 to 214. The numerals from “1” to “12” may be displayed on both the upper face display unit 210 and the respective side face display units.

Also with the display device performed in the modification 1 of the first display mode, the wristwatch 1 according to embodiment becomes a wristwatch having a new value not obtained by the prior art.

### [Second Display Mode]

FIG. 8 is a view for describing a second display mode of the wristwatch 1 according to the embodiment. The second display mode of the wristwatch 1 according to the embodiment describes, in the same manner as the first display mode mentioned previously, the case where five display units 210 to 214 are set in an analog watch display mode. In the second display mode, in the same manner as the modification 1 (see FIG. 7) of the first display mode described previously, assume that numerical values from “1” to “12” that indicate time are displayed on the respective side-face-use organic EL display sheets 211 to 214. Further, in the second display mode of the wristwatch 1 according to the embodiment, the display control unit 450 controls the displays of five respective display units 210 to 214 as if the inside of the wristwatch body 100 is viewed in a see-through manner as viewed from a user, and the time display in the analog time display mode is performed in the normal left-and-right display on the third side face display unit 213 and the fourth side face display unit 214 of the wristwatch body 100 and is performed in the reverse left-and-right display on the first side face display unit 211 and the second side face display unit 212.

To perform the display control of the respective organic EL display sheets 210 to 214 as if the inside of the wristwatch body 100 is viewed in a see-through manner means that the display control is performed as if the wristwatch body 100 is a transparent vessel. More specifically, the display control is performed such that the user can visually recognize side faces in the inside of the wristwatch body 100 (a side face 111a on an inner side of the first side face 111 and a side face 112a on an inner side of a second side face 112) respectively, and the user can visually recognize an inner bottom face 115a of the wristwatch body 100. In this case, “transparent vessel” may be a non-colored transparent vessel or a colored transparent vessel having light transmissivity.

By performing such a display control, as viewed from the user, the inside of the wristwatch body 100 appears in a see-through manner that is, the wristwatch body 100 appears as if the wristwatch body 100 is a transparent vessel. Particularly, “11”, “12”, “11”, “1” and “1”, “3”, “4”, displayed on the first side face display unit 211 and the second side face display unit 212 that are not originally viewed from the user has a feeling as if the wristwatch body 100 is a transparent vessel and the inside of the wristwatch body 100 is viewed in a see-through manner, since the individual numerals are displayed in the reverse left-and-right display.

Further, in the second display mode, the hour hand 230 and the minute hand 240 are displayed on the upper face display unit 210 that appeared transparent as viewed from the user. With respect to the minute hand 240, the case is described where the minute hand 240 is displayed only on the upper face display unit 210. However, in the same manner as the first display mode, the minute hand 240 may be displayed such that the minute hand 240 extends over one side face display unit out of the respective side face display units 211 to 214.

In this manner, in the second display mode, as viewed from the user, the inside of the wristwatch 100 body appears in a see-through manner, the display of the numerical values that indicate the time in an analog watch display mode becomes the normal left-and-right display on the third side face display unit 213 and the fourth side face display unit 214, and becomes the reverse left-and-right display in areas of the upper face display unit 210 corresponding to the first side face display unit 211 and the second side face display unit 212 described above. Accordingly, the wristwatch 1 according to the embodiment becomes a wristwatch having a new value not obtained by the prior art. Since the first side face display unit 211 and the second side face display unit 212 described above are not viewed from the user, the numerical values that indicate the time in the analog watch display mode and other displays may not be performed. However, to prevent people other than the user from having a discomfort when they view the wristwatch, in the same manner as the case of the third side face display unit 213 and the fourth side face display unit 214, the display of the numerical values that indicate the time may be the normal left-and-right display.

### [Third Display Mode]

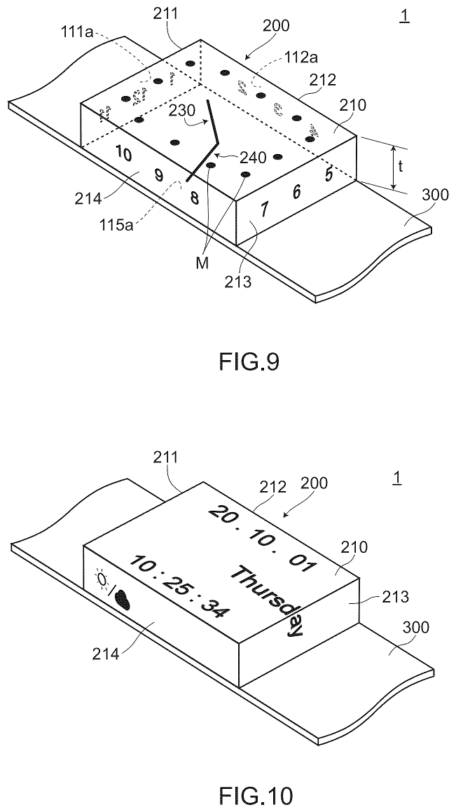

FIG. 9 is a view for describing the third display mode of the wristwatch 1 according the embodiment. The third display mode of the wristwatch 1 according to the embodiment also adopts, in the same manner as the first display mode and the second display mode described above, the case where five display units 210 to 214 adopt an analog watch display mode.

Also in the third display mode of the wristwatch 1 according to the embodiment, in the same manner as the second display mode, the display control unit 450 performs a display control where the inside of the wristwatch body 100 appears in a see-through manner as viewed from the user, that is, the display control where the wristwatch body 100 appears as a transparent vessel. However, in the third display mode, the display control unit 450 performs the display control where the hour hand 230 and the minute hand 240 rotate in a state where the hour hand 230 and the minute hand 240 are positioned in the inside of the wristwatch body 100.

In this mode, the display control where the inside of the wristwatch body 100 appears in a see-through manner when the user views the wristwatch body 100 at the time of using the wristwatch 1 can be realized, in the same manner as the second display mode, by allowing the user to visually recognize side faces in the wristwatch body 100 (the side face 111a on an inner side of the first side face 111 and the side face 112a on an inner side of the second side face 112), by allowing the user to visually recognize the inner bottom face 115a of the wristwatch body 100 as viewed from the user. In this mode, in the same manner as the second display mode, “11”, “12”, “1”, and “1”, “3”, “4” that are displayed on the first side face display unit 211 and the second side face display unit 212 which are originally not viewed from the user are displayed in the reverse left-and-right display as viewed from a user.

Further, in the third display mode, in addition to the display performed in a state where the inside of the wristwatch body 100 appears in a see-through manner, the display is performed such that the hour hand 230 and the minute hand 240 rotate in a state that the hour hand 230 and the minute hand 240 are positioned in the inside of the wristwatch body 100. In this display mode, to display the hour hand 230 and the minute hand 240 in a state where the hour hand 230 and the minute hand 240 are positioned in the inside of the wristwatch body 100 means displaying of the hour hand 230 and the minute hand 240 in a state where a rotary shaft portion Po of the hour hand 230 and the minute hand 240 is disposed at an approximately intermediate position in a thickness t direction of the wristwatch body 100, and the hour hand 230 and the minute hand 240 are displayed such that the hour hand 230 and the minute hand 240 are housed in the inside of the wristwatch body 100.

When the display control unit 450 performs such a display control, in the same manner as the second display mode describe above, as viewed from the user, the side face 111a on an inner side of the first side face 111 of the wristwatch body 100 and the side face 112a on the inner side of the second side face 112 of the wristwatch body 100 are respectively visually recognized, and the inner bottom surface 115a of the wristwatch body 100 can be visually recognized. Further, in the third display mode, from the user, it appears that the hour hand 230 and the minute hand 240 rotate in a state that the hour hand 230 and the minute hand 240 are positioned in the inside of the wristwatch body 100.

In this manner, in the third display mode, as viewed from the user, the display control unit 450 performs a control as if the inside of the wristwatch body is viewed in a see-through manner, and the hour hand and the minute hand rotate in a state where the hour hand and the minute hand are positioned in the inside of the wristwatch body. Accordingly, the wristwatch 1 according to the embodiment becomes a wristwatch that has a new value not obtained by the prior art.

### [Fourth Display Mode]

FIG. 10 is a view for describing the fourth display mode of the wristwatch 1 according to the embodiment. In the first to third display modes described above, the description is made with respect to the respective display modes in the case where five display units 210 to 214 are set in an analog watch display mode. On the other hand, the fourth display mode is a case where five display units 210 to 214 are set in a digital watch display mode. In this display mode, the digital watch display mode is not a mode where the time is indicated by the hour hand and the minute hand, but is a display mode where the time is displayed by numerical values. Further, in the fourth display mode, assume that not only the time but also other information such as date and the day of the week are displayed. In making the wristwatch 1 perform such a display, for example, the user can set five display units 210 to 214 in a digital watch display mode by selecting “digital watch display”, for example, from a display image selection screen that functions as the display image selection unit 410.

By setting five display units 210 to 214 in a digital watch display mode, for example, as illustrated in FIG. 10, on the upper face display unit 210, for example, besides setting of the display where the current time of 10 hours, 25 minutes and 34 seconds as “10:25:34”, the date of today such as Oct. 1, 2020 is displayed as “20. 10. 01”, and today is displayed as “Thursday” as the day of the week. Further, as other information, a weather forecast of today is displayed on the respective side face display units 211 to 214 (the fourth side face display unit 214 in the example illustrated in FIG. 10) by a weather mark or the like. The various information may be displayed in a streaming manner on the respective display units. As an example, the day of the week can be displayed in a streaming manner, and various information are displayed one after another following the day of the week.

In this manner, in the fourth display mode, various information including the digital watch display can be displayed as images using five display units 211 to 214 and, at the same time, some information (images) or all information (images) can be displayed in a streaming manner. Accordingly, the wristwatch 1 according to the embodiment becomes a wristwatch having a new value not obtained by the prior art.

### [Fifth Display Mode]

In the first to fourth display modes described above, the description is made with respect to the case where five display units 210 to 214 are used in the watch display mode (the analog time display mode or the digital time display mode). However, the wristwatch 1 according to the embodiment can be set to various display modes besides the watch display mode. In the fifth display mode, the case is described where display modes other than the watch display mode (hereinafter referred to other display modes) are set.

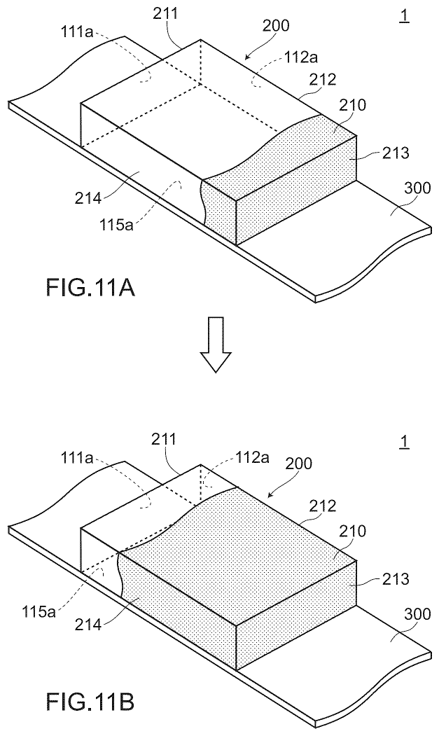

FIG. 11A and FIG. 11B are views for describing a fifth display mode of the wristwatch 1 according to the embodiment. As illustrated in FIG. 11A and FIG. 11B, the fifth display mode is a display mode where, as viewed from a user, the display control unit 450 performs a control as if a transparent vessel is filled with a liquid, and the increase and the decrease of the liquid are repeated in a transparent vessel. To allow the wristwatch 1 according to the embodiment to perform such a display, the user selects, for example, “other display mode” from a display image selection screen that functions as the display image selection unit 410 and, further, selects, for example, “a mode 1” from a plurality of choices among “other display modes”. Accordingly, in the wristwatch 1 according to the embodiment, the display in the fifth display mode illustrated in FIG. 11A and FIG. 11B is performed.

The fifth display mode is a display mode where, as viewed from a user, the display control unit 450 performs a control as if the wristwatch body 110 is a transparent vessel and the transparent vessel is filled with a liquid (indicated by grey color). Then, the liquid filled in the transparent vessel performs an operation of repeating the increase and the decrease of the liquid while swinging. Since the liquid performs such an operation in the transparent vessel, a user perceives joy and wonder simply by watching the movement of the liquid so that the user is not bored in watching the display. A display control may be performed where color of the liquid gradually changes.

In this manner, in the fifth display mode, the display mode is performed where, as viewed from the user, the display control unit 450 performs a control as if the transparent vessel is filled with the liquid and the liquid repeats the increase and the decrease thereof in the transparent vessel. Accordingly, the wristwatch 1 according to the embodiment can, while maintaining its original function as a wristwatch, perform a display other than the time display and hence, the wristwatch 1 according to the fifth embodiment becomes a wristwatch having a new value not obtained by the prior art.

### Sixth Embodiment

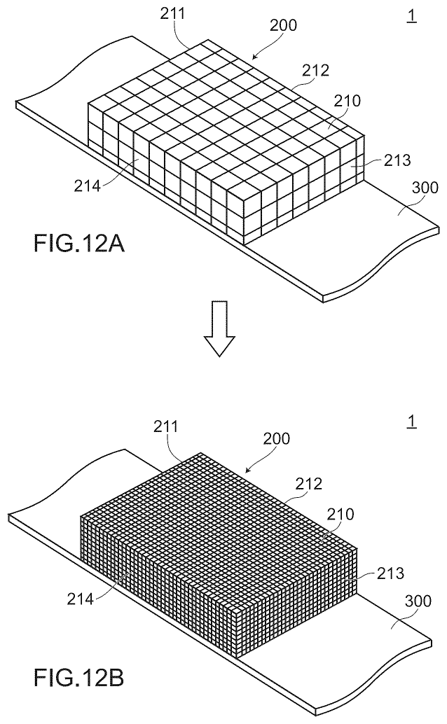

FIG. 12A and FIG. 12 are views for describing a sixth display mode of the wristwatch 1 according to the embodiment. The sixth display mode is also, in the same manner as the fifth display mode, a display mode of a case where various display modes other than the time display mode are set. In this case, the user selects, for example, “other display modes”, from a display image selection screen that functions as the display image selection unit 410 and, further, selects, for example, “a pattern 2” from a plurality of choices in “other display modes”. Accordingly, in the wristwatch 1 according to the embodiment, the display in the sixth display mode illustrated in FIG. 12A and FIG. 12B is started.

In the sixth display mode, as illustrated in FIG. 12A and FIG. 12B, five display units 210 to 214 are made to display a lattice pattern. Then, as illustrated in FIG. 12A and FIG. 12B, the display is performed in such a manner where the size of grids formed by the lattice pattern is changed. In this case, the change of the size of the grids may be continuously and gradually performed, or may be performed in a stepwise manner such as a large size, an intermediate size and a small size. Further, the display may be performed in such a manner that the entirety of the lattice pattern moves in the direction from the right to the left illustrated in the drawing, for example.

In this manner, in the sixth display mode, a predetermined pattern can be displayed on the entirety of five display faces, the size of the pattern can be changed, and the pattern is displayed in a streaming manner and hence, the wristwatch 1 according to the embodiment can, while maintaining its original function as a watch, performs a display other than the time display whereby it is possible to provide the wristwatch that has a new value not obtained by the prior art. That is, the wristwatch 1 according to the embodiment becomes a wristwatch having a new value not obtained by the prior art.

### [Seventh Display Mode]

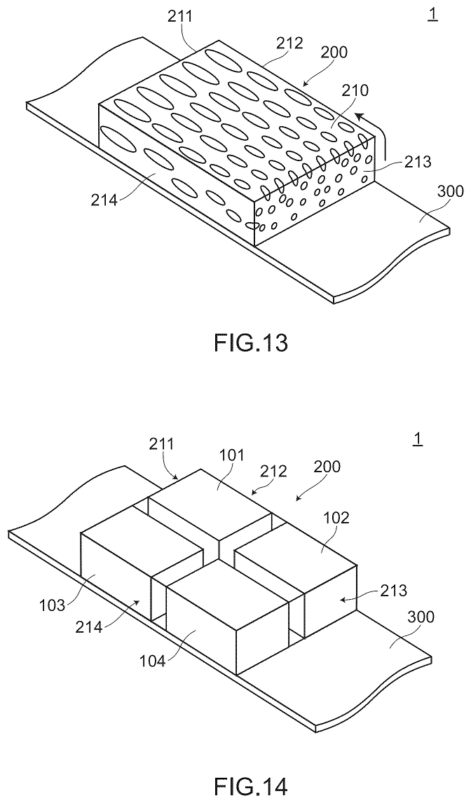

FIG. 13 s a view for describing a seventh display mode of the wristwatch 1 according to the embodiment. The seventh display mode is also, in the same manner as the fifth display mode and the sixth display mode, a display mode of a case where various display modes other than the time display mode are set. In this case, the user selects, for example, “other display modes”, from a display image selection screen that functions as the display image selection unit 410 and, further, selects, for example, “a pattern 3” from a plurality of choices among “other display modes”. Accordingly, assume that the display illustrated in FIG. 13 is started.

In the seventh display mode, as illustrated in FIG. 13, the display mode is performed where, as viewed from the user, the display control unit 450 performs a control as if a pattern formed of a large number of drops of water streams on five display units 210 to 214 respectively. In this case, for example, a display control is performed such that a large number of drops of water are generated in a spring-out manner on the third side face display unit 213, the generated individual drops of water stream on the upper face display unit 210, the fourth side face display unit 214, the second side face display unit 212 and the first side face display unit 211 while gradually growing. A user perceives joy and wonder simply by watching the movement of the drops of water so that the user is not bored in watching the display. A display control may be also performed where colors of the drops of water change individually or the colors of the drops of water change as the drops of water grow.

In this manner, in the seventh display mode, a display control can be performed such that a pattern formed of drops of water is displayed over the entirety of five display units and the pattern streams while changing the size of the pattern or the color of the pattern. Accordingly, the wristwatch according to the embodiment can, while maintaining its original function as a wristwatch, performs a display other than the time display. Accordingly, the wristwatch 1 according to the embodiment becomes a wristwatch having a new value not obtained by the prior art.

### [Eighth Display Mode]

FIG. 14 s a view for describing an eighth display mode of the wristwatch 1 according to the embodiment. The eighth display mode is also, in the same manner as the fifth display mode to the seventh display mode, a display mode of a case where various display modes other than the time display mode are set. In this case, the user selects, for example, “other display modes”, from a display image selection screen that functions as the display image selection unit 410 and, further, selects, for example, “a pattern 4” from a plurality of choices among “other display modes”. Accordingly, assume that the display illustrated in FIG. 14 is started.

In the eighth display mode, as illustrated in FIG. 14, the display mode is performed where, as viewed from the user, the display control unit 450 performs a control as if the wristwatch 1 having a rectangular parallelepiped shape is divided into a plurality of blocks, that is, for example, the wristwatch 1 having a rectangular parallelepiped shape is divided into four blocks as illustrated in FIG. 14 and, then, four respective blocks are further finely divided and, thereafter, these blocks are returned to an original state (a state before the division). In this case, a display control where colors of individual blocks are changed or color is changed for each predetermined area may be performed.

As has been described heretofore, according to the eighth display mode, the display is performed where, as viewed from the user, the display control unit 450 performs a control as if the wristwatch 1 having a rectangular parallelepiped shape is divided into a plurality of blocks. Accordingly, the wristwatch 1 according to the embodiment can, while maintaining its original function as a wristwatch, perform a display other than the time display. Accordingly, the wristwatch 1 according to the embodiment becomes a wristwatch having a new value not obtained by the prior art.

### [Ninth Display Mode]

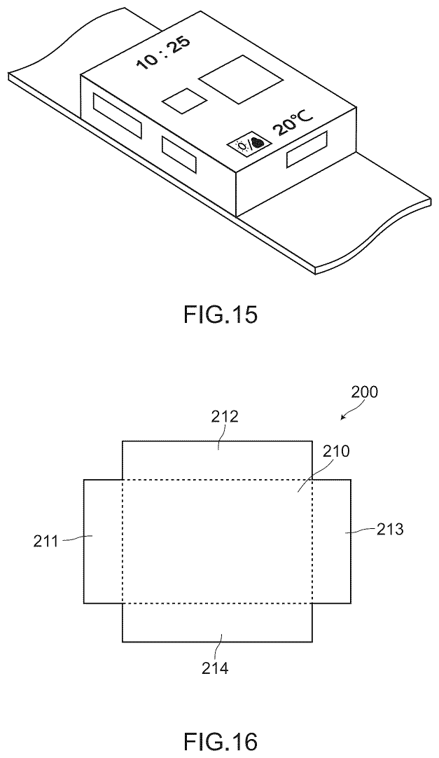

FIG. 15 is a view for describing a ninth display mode of the wristwatch 1 according to the embodiment 1. The ninth display mode is also, in the same manner as the fifth display mode to the eight display mode, a display mode of a case where various display modes other than the time display mode are set. However, although the fifth display mode to the eighth display mode are the display modes for displaying a pattern, the ninth display mode is a case where a display mode for displaying composite images is displayed on the wristwatch 1 according to the embodiment 1. In this display mode, “composite images” means to display various images such as a time image, a calendar image for each month, and photographs on five display units 210 to 214 in a state where various images move in a linked manner or are associated with each other. In this case, the user selects, for example, “composite” from a display image selection screen. Accordingly, the display illustrated in FIG. 15 is performed. In this case, various images can be displayed not only on the upper face display unit 210 of the wristwatch 1 but also on the respective side face display units 211 to 214 of the wristwatch 1. Accordingly, various kind of composite images can be displayed.

In this manner, in the ninth display mode, various composite images can be displayed using the entirety of five display units and hence, the wristwatch 1 according to the embodiment can, while maintaining its original function as a watch, also perform a display other than the time display. Accordingly, the wristwatch 1 according to the embodiment becomes a wristwatch having a new value not obtained by the prior art.

Heretofore, the description has been made with respect to the first display mode to the ninth display mode as the display modes of the wristwatch 1 according to the embodiment 1. However, these display modes are provided for an exemplifying purpose, and various displays can be performed. For example, the display control unit 450 performs a control as if the wristwatch 1 having a rectangular parallelepiped shape appears as an aquarium and fishes are swimming in the aquarium, or the display is performed where a process in which a patterned flower blooms from a bud state is displayed in a fast-streaming manner.

As has been described heretofore, according to the wristwatch 1 of the embodiment, the display of images can be performed in various modes on five display units 210 to 214 (the upper face display unit 210 and the respective side face display units 211 to 214) of the wristwatch body 100 having a rectangular parallelepiped shape. Further, in performing the display of the images on five display units 210 to 214, the displays of five respective display units are controlled such that the images displayed on five respective display units 210 to 214 are moved in a linked manner or are linked to each other. Accordingly, the wristwatch 1 can be used in various applications and hence, it is possible to provide a wristwatch having a new value not provided by a prior art.

The present invention is not limited to the above-mentioned embodiments, and the present invention can be carried out in various modifications without departing from the gist of the present invention. For example, the following modifications can be also carried out.

(1) In the above-mentioned embodiment, in the display modes (the first display mode to the third display mode) where five display units 210 to 214 adopt an analogue watch display mode, the reference is not made with respect to the second hand. However, the second hand can be also displayed in addition to the hour hand and the minute hand.

That is, according to the present invention, in the case where the display mode is an analogue watch display mode where the time is displayed using the plurality of hands, the display control unit 450 controls the respective displays of five display units described above such that at least the longest hand out of the plurality of hands extends from the upper face display unit 210 over one side face display unit out of four side face display units (the respective side face display units 211 to 214), and with respect to the hand extending over the first side face display unit, a portion displayed on the upper face display unit 210 and a portion displayed on one side face portion are rotated in a linked a manner.

In this embodiment, in a case where the plurality of hands are formed of the hour hand and the minute hand, in general, the minute hand is longer than the hour hand. Accordingly, as described in above-mentioned first display mode, the minute hand 230 is displayed such that the minute hand 230 extends from the upper face display unit 210 over one side face display unit out of the respective side face display units 211 to 214.

In the case where the plurality of hands are formed of the hour hand, the minute hand and the second hand, when the respective lengths of the respective hands satisfy the relationship of hour hand <minute hand <second hand (here, “<” indicating inequality sign), the display is performed such that only the second hand extends from the upper face display unit 210 over one side face display unit out of the respective side face display units 211 to 214. As described above, the expression that “at least the longest hand” out of the plurality of hands is used. Accordingly, the display may be performed such that not only the longest second hand but also the second longest minute hand extends from the upper face display unit 210 over one side face display unit out of the respective side face display units 211 to 214.

In the case where the plurality of hands are formed of the hour hand, the minute hand and the second hand, when the respective lengths of the respective hands satisfy the relationship of hour hand <second hand <minute hand, the display is performed such that only the minute hand extends from the upper face display unit 210 over one side face display unit out of the respective side face display units 211 to 214. Also in this case, the expression that “at least the longest hand” out of the plurality of hands is used. Accordingly, the display may be performed such that not only the longest minute hand but also the second longest second hand extends from the upper face display unit 210 over one side face display unit out of the respective side face display units 211 to 214.

In the case where the plurality of hands are formed of the hour hand, the minute hand and the second hand, when the respective lengths of the respective hands satisfy the relationship of hour hand <minute hand=second hand, the display is performed such that the minute hand and the second hand extend from the upper face display unit 210 over one side face display unit out of the respective side face display units 211 to 214. In this manner, the display is performed such that “at least the longest hands” extend from the upper face display unit 210 over one side face display unit out of the respective side face display units 211 to 214.

(2) In the respective display modes of the above-mentioned embodiment, the description has been made with respective to the case where some displays (the analogue watch display, the digital watch display, and the various pattern displays) are performed on five display units 210 to 214 of the wristwatch 1. However, it is also set a non-display mode where none is displayed on five display units 210 to 214. In this non-display mode, no pattern is displayed over the entire areas of five display units. In this manner, by enabling setting of the non-display mode, although the wristwatch is a wristwatch that originally displays time, in the non-display mode, the wristwatch becomes a wristwatch that makes a user not recognize the presence of the time display. Accordingly, it is possible to provide the wristwatch having a new value not obtained by the prior art.

(3) In the respective display modes in the above-mentioned embodiment, colors of display contents are not referred. However, it is needless to say that the respective display modes are performed in a so-called color display. For example, in the case of performing the analogue watch display, the hour hand and the minute hand are displayed in different colors or the display is performed such that the color changes when the time becomes every hour on the hour such as one o'clock or two o'clock.

(4) In the above-mentioned embodiment, the case is exemplified where five display units 210 to 214 are formed of five organic EL display sheets (the upper-face-use organic EL display sheet 210, the first-side-use organic EL display sheet 211, the second-side-use organic EL display sheet 212, the third-side-use organic EL display sheet 213, and the fourth-side-use organic EL display sheet 214). However, five display units 210 to 214 may be formed of one organic EL display sheet.

FIG. 16 is a view illustrating the case where five display units 210 to 214 are formed of one organic EL display sheet. In the case where five display units 210 to 214 are formed of one organic EL display sheet, the organic EL display sheet has a shape illustrated in FIG. 16. In this case, the one organic EL display sheet has the shape where the first-side-use organic EL display sheet 211, the second-side-use organic EL display sheet 212, the third-side-use organic EL display sheet 213, and the fourth-side-use organic EL display sheet 214 extend in four directions from the upper-face-use organic EL display sheet 210 that is disposed at the center of the organic EL display sheet. One organic EL display sheet having a such a shape is folded along a broken line illustrated in FIG. 16 such that one organic EL display sheet conforms to an outer shape of the wristwatch body 100 (see FIG. 3A), and is laminated to the wristwatch body 100.

Accordingly, the wristwatch 1 having one organic EL display sheet having such a shape has substantially the same configuration as the wristwatch 1 according to the embodiment described above. In the case where five display units 210 to 214 are formed of one organic EL display sheet, a gap is not formed at folding portions (portions indicated by a broken line) and hence, it is unnecessary to embed the folding portions with the black member described with respect to FIG. 5. On the other hand, there may be a case where a gap that corresponds to a thickness of organic EL sheet is formed at portions corresponding to the corner portions of the respective side face display portions and hence, it is preferable to embed these portions with the black member. That is, in one organic EL display sheet illustrated in FIG. 16, a gap that corresponds to a thickness of the organic EL display sheet is formed between the first-side-use organic EL display sheet 211 and the second-side-use organic EL display sheet 212, between the second-side-use organic EL display sheet 212 and the third-side-use organic EL display sheet 213, between the third-side-use organic EL display sheet 213 and the fourth-side-use organic EL display sheet 214, and between the fourth-side-use organic EL display sheet 214 and the first-side-use organic EL display sheet 211. Accordingly, it is preferable to embed the black member in these gaps.

In the case where five display units 210 to 214 are formed of one organic EL display sheet, it is possible to make the images displayed on the upper face and the respective side faces move in a linked manner or to make the images displayed on the upper face and the respective side faces associated with each other and hence, driving of the organic EL display sheet can be simplified. Accordingly, with respect to the supply of power to the organic EL display sheet side from the wristwatch body 100 side and the supply of electric signals to the organic EL display sheet side from the wristwatch body 100 side, it is sufficient to supply the power and the electricity to one organic EL display sheet. Accordingly, it is also sufficient to provide an electrode group to one portion that corresponds to the wristwatch body 100 side and to provide an electrode group to one portion that corresponds to one organic EL display sheet side.

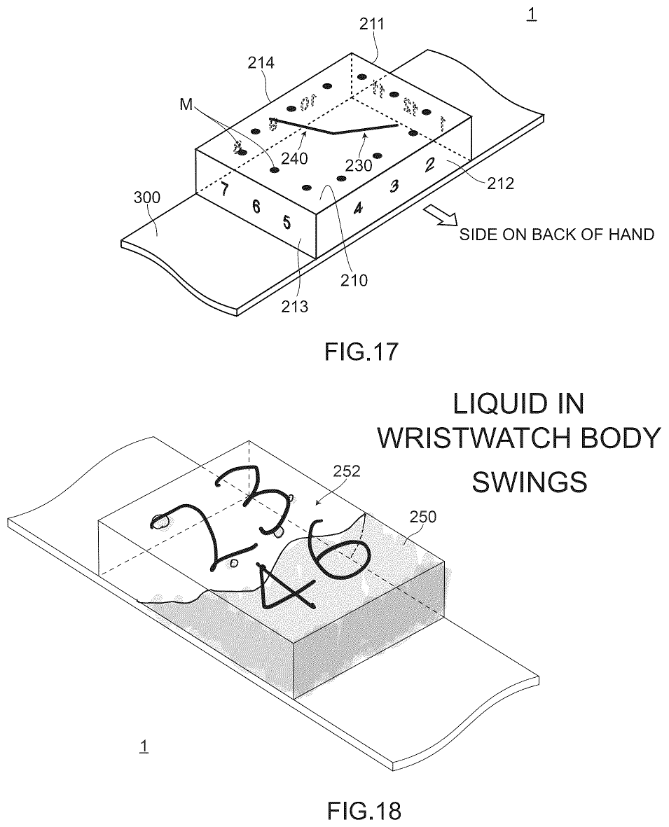

(5) In the above-mentioned embodiment, the case is described where the user sees the wristwatch 1 in a state where the user slightly bends an elbow of his/her arm toward his/her body (an abdomen side or a chest side). However, there is a case where the user sees the wristwatch 1 by further strongly bending his/her arm. FIG. 17 is a view for describing the case where the user sees the wristwatch 1 by strongly bending his/her arm in the second display mode of the wristwatch 1 according to the embodiment.

In the second embodiment (see FIG. 8) described in the above-mentioned embodiment, in the time display in an analogue watch display mode, the display control unit 450 performs a display control of the third side face display unit 213 and the fourth side face display unit 214 such that a normal left-and-right display is performed on the third side face display unit 213 and the fourth side face display unit 214, and performs a display control of the upper face display unit 210 as if a reverse left-and-right display is performed in the first side face display unit 211 and the second side face display unit 212 as viewed from the user. This is because the third side face display unit 213 and the fourth side face display unit 214 are disposed at the positions that enter eyes of the user as viewed from the user.

However, in the case where the user sees the wristwatch 1 by strongly bending his/her arm, as shown in FIG. 17, there is a case where the second side face display unit 212 and the third side face display unit 213 enter eyes of the user as viewed from a user side. Accordingly, in this case, it is preferable that the display control unit 450 perform a display control of the second side face display unit 212 and the third side face display unit 213 such that a normal left-and-right display is performed on the second side face display unit 212 and the third side face display unit 213, and perform a display control of the upper side face display unit 210 as if a reverse left-and-right display is performed in the first side face display unit 211 and the fourth side face display unit 214 as viewed from the user.

(6) In the above-mentioned embodiments, the description has been made with respect to the first display mode to the ninth display mode. However, the display control unit 450 can perform the display in other display modes.

### [Tenth Display Mode]

FIG. 18 is a view for describing another display mode (tenth display mode) of the wristwatch 1 according to the embodiment. The tenth display mode is a display mode similar to the fifth display mode (see FIG. 11A and FIG. 11B). However, as illustrated in FIG. 18, as viewed from the user, the tenth display mode is a display mode where the display control unit 450 performs a control as if the wristwatch 1 is filled with a liquid 250, the liquid 250 swings and, further, a present time 252 is displayed on the upper side face display unit 210. In the wristwatch 1 according to the embodiment, the display control unit 450 controls the displays of five respective display units 210 to 214 such that the above-mentioned display mode can be realized.

### [Eleventh Display Mode]

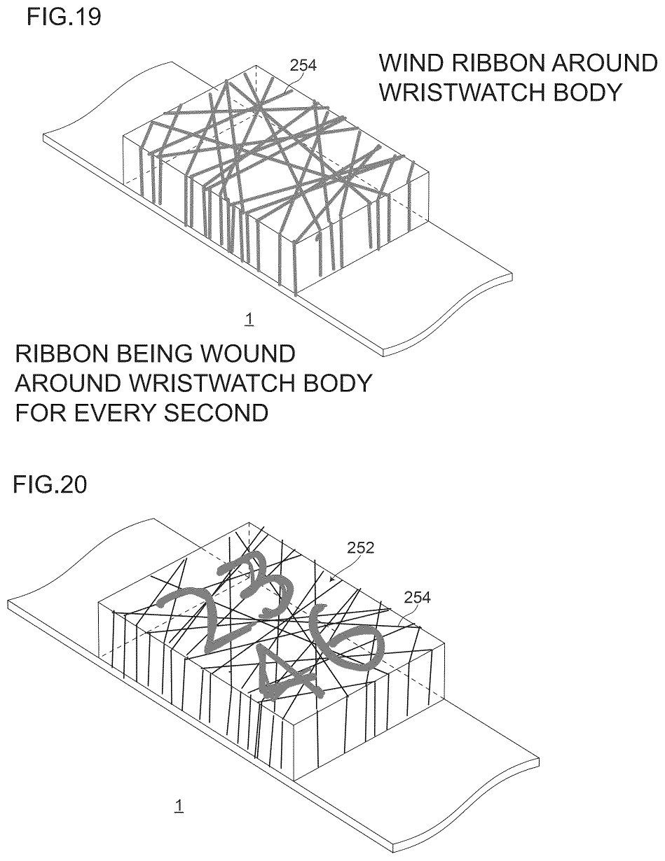

FIG. 19 is a view for describing another display mode (eleventh display mode) of the wristwatch 1 according to the embodiment. As illustrated in FIG. 19, the eleventh display mode is a display mode displaying a mode where a ribbon 254 is wound around the wristwatch 1. In the eleventh display mode, a mode may be displayed where the ribbon 254 is wound around the wristwatch 1 and the wound ribbon 254 is loosened with a lapse of time. In the wristwatch 1 according to the embodiment, the display control unit 450 controls the displays of five respective five display units 210 to 214 such that the above-mentioned display mode can be realized.

### [Twelfth Display Mode]

FIG. 20 is a view for describing another display mode (twelfth display mode) of the wristwatch 1 according to the embodiment. As illustrated in FIG. 20, the twelfth display mode is a display mode displaying a mode where the present time 252 is displayed on the upper side face display unit 210 in addition to the display of the eleventh display mode. In the wristwatch 1 according to the embodiment, the display control unit 450 controls the displays of five respective display units 210 to 214 such that the above-mentioned display mode can be realized.

### [Thirteenth Display Mode]

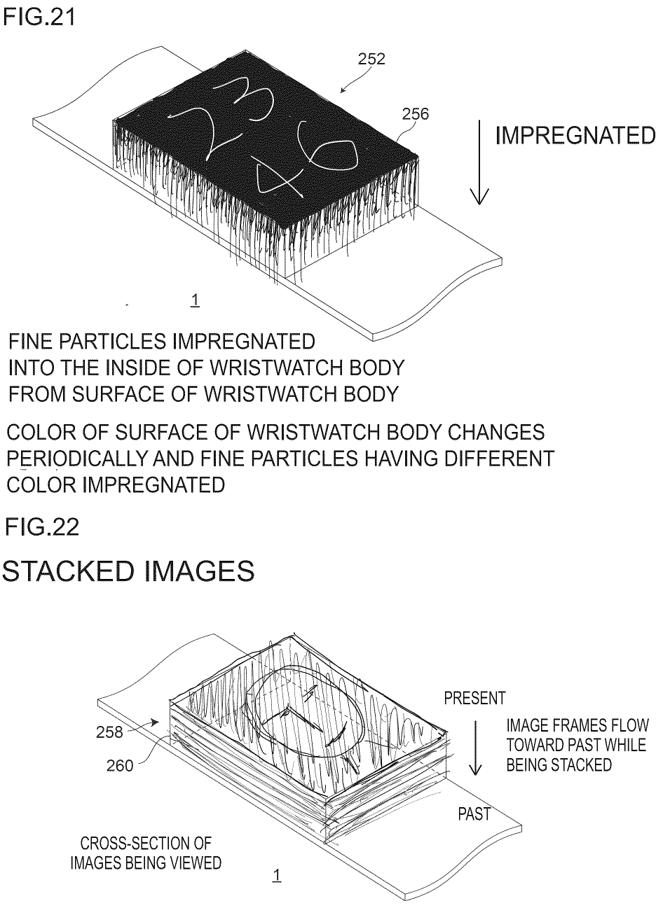

FIG. 21 is a view for describing another display mode (thirteenth display mode) of the wristwatch 1 according to the embodiment. As illustrated in FIG. 21, the thirteenth display mode is a display mode where fine particles 256 are infiltrated into the wristwatch 1 from an upper face of the wristwatch 1 to a bottom face of the wristwatch 1. In the thirteenth display mode, a display mode may be adopted where the color of a surface changes periodically and fine particles having different color are infiltrated into the wristwatch 1. In the wristwatch 1 according to the embodiment, the display control unit 450 controls the displays of five respective display units 210 to 214 such that the above-mentioned display mode can be realized.

### [Fourteenth Display Mode]

FIG. 22 is a view for describing another display mode (fourteenth display mode) of the wristwatch 1 according to the embodiment. As illustrated in FIG. 22, the fourteenth display mode is a display mode where a mode that a plurality of images 258 that form frames of images are stacked from the present (an upper face) to the past (a bottom face) is displayed. Along with a lapse of time, on the upper display unit 210, the more past image out of the plurality of images 258 is displayed. Further, on four side face display units 211 to 214, end faces 260 of the plurality of images 258 are displayed. In the wristwatch 1 according to the embodiment, the display control unit 450 controls the displays of the respective five display units 210 to 214 such that the above-mentioned display mode can be realized.

### [Fifteenth Display Mode]

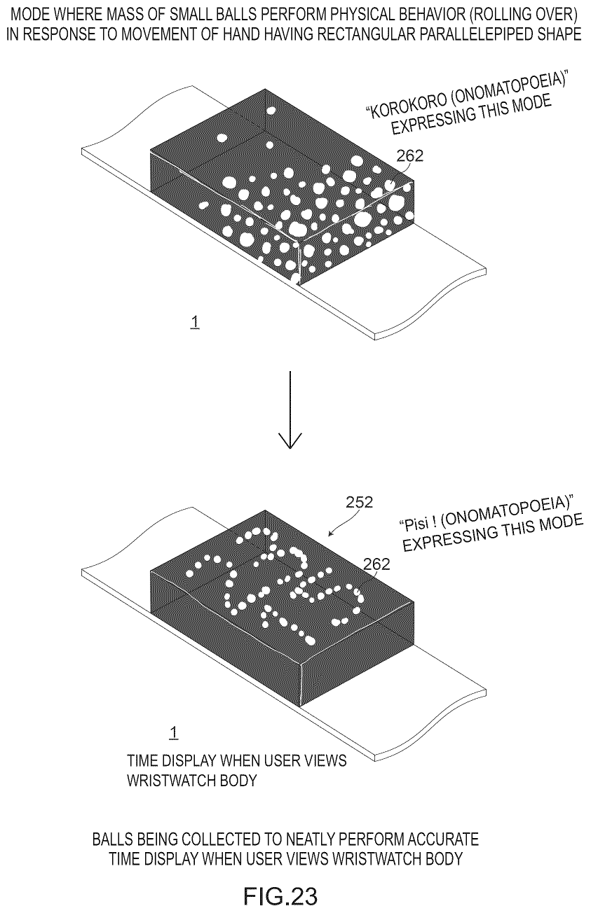

FIG. 23 is a view for describing another display mode (fifteenth display mode) of the wristwatch 1 according to the embodiment. As illustrated in FIG. 23, the fifteenth display mode is a display mode in which a mode is displayed where small balls 262 are dispersed and move at random in a rectangular parallelepiped shape in an initial state and, thereafter, with a lapse of time, the small balls 262 gather on an upper surface so that the present time 252 appears. The small balls 262 may move, for example, along with the lapse of time or in response to the movement of a hand of the user. In the wristwatch 1 according to the embodiment, the display control unit 450 controls the displays of the respective five display units 210 to 214 such that the above-mentioned display mode can be realized.

### [Sixteenth Display Mode]

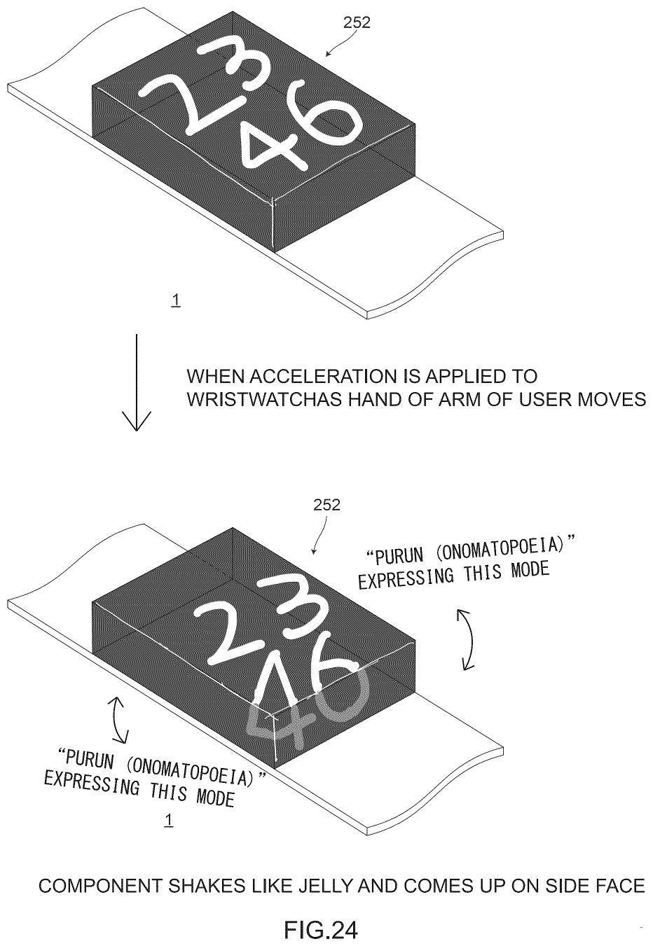

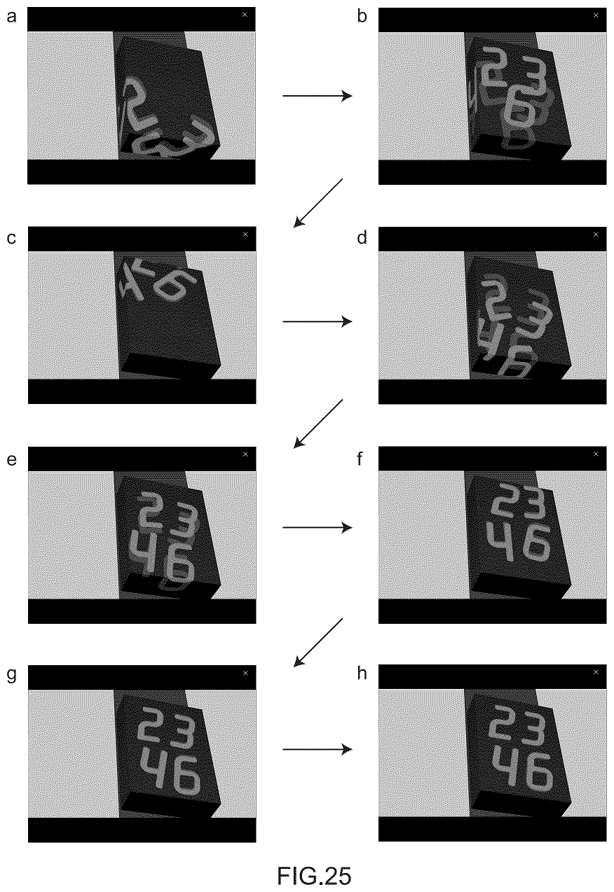

FIG. 24 and FIG. 25 are views for describing another display mode (sixteenth display mode) of the wristwatch 1 according to the embodiment. The sixteenth display mode is, as illustrated in FIG. 24 and FIG. 25, a display mode where the present time 252 is displayed on the upper face display unit 210 as an initial state, and when acceleration is applied to the wristwatch as an arm of a user moves, for example, the present time 252 shakes like a jelly in response to the movement of the arm and comes up on a side face. FIG. 25 illustrates a series of movement in which the present time comes up on one or more side face display units out of the side face display units 211 to 214 in addition to the upper face display unit 210. As illustrated in FIG. 25, four numerals that form the present time come up not only on the upper face display unit 210 but also on four side faces thus changing its display mode from a to h in FIG. 25. In the wristwatch 1 according to the embodiment, the display control unit 450 controls the displays of the respective five display units 210 to 214 such that the above-mentioned display mode can be realized.

### [Seventeenth Display Mode]

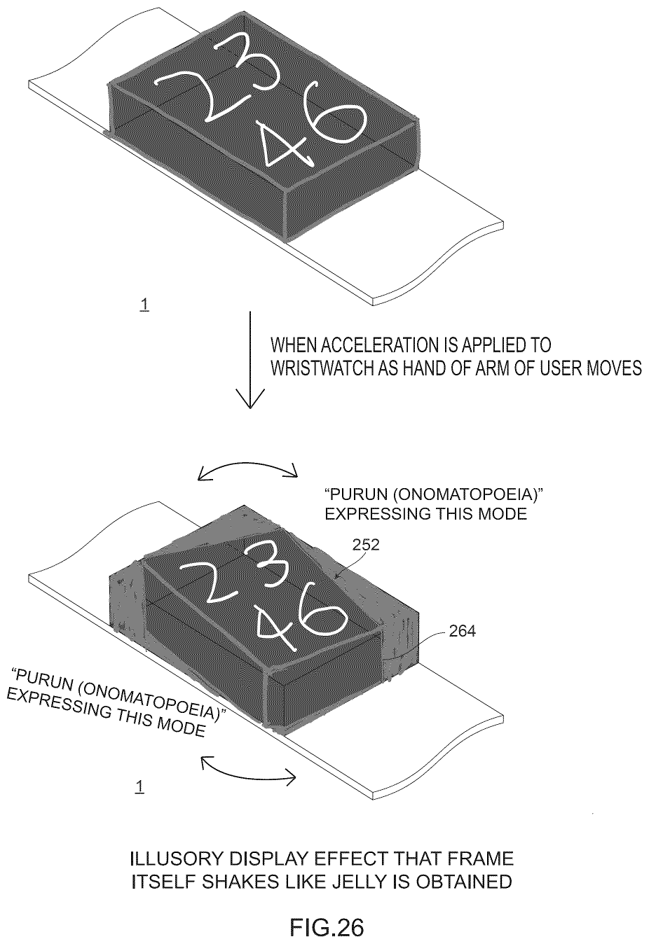

FIG. 26 is a view for describing another display mode (seventeenth display mode) of the wristwatch 1 according to the embodiment. The seventeenth display mode is, as illustrated in FIG. 26, a display mode where the present time 252 is displayed on the upper face display unit 210 as an initial state, and when acceleration is applied to the wristwatch as an arm of a user moves, for example, it appears that a pseudo wristwatch frame 264 shakes like a jelly in the inside of the wristwatch 1 in response to the movement of the arm (an illusory display mode). In the wristwatch 1 according to the embodiment, the display control unit 450 controls the displays of the respective five side face display units 210 to 214 such that the above-mentioned display mode can be realized.

### [Eighteenth Display Mode]

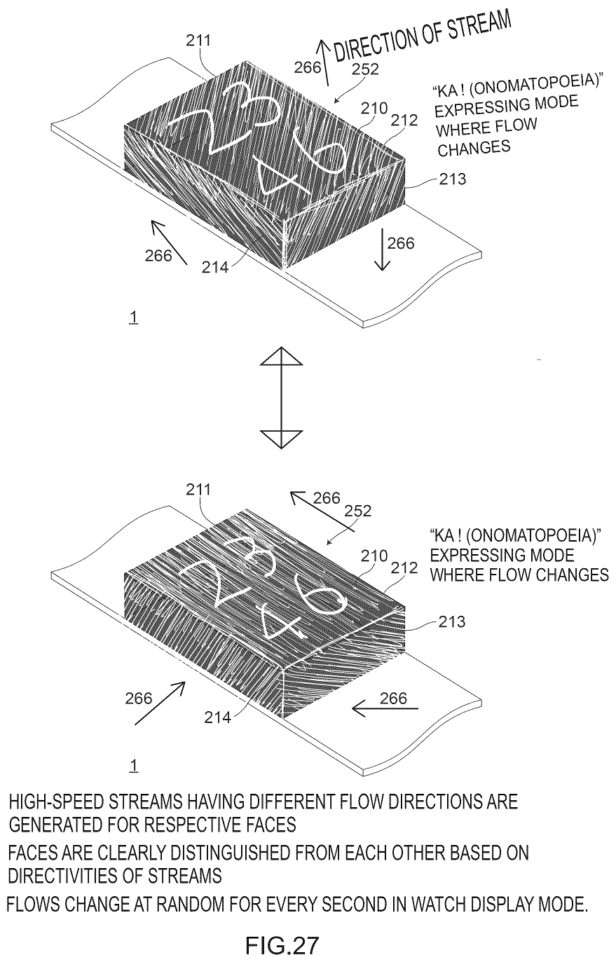

FIG. 27 is a view for describing another display mode (eighteenth display mode) of the wristwatch 1 according to the embodiment. The eighteenth display mode is, as illustrated in FIG. 27, a display mode where streams having different flow directions 266 are generated for respective display faces (the upper display face unit 210 and four display units 211 to 214), and the flows change as illustrated in an upper view and a lower view in FIG. 27 for every 1 second, for example. In the wristwatch 1 according to the embodiment, the display control unit 450 controls the displays of the respective five display units 210 to 214 such that the above-mentioned display mode can be realized.

### [Nineteenth Display Mode]

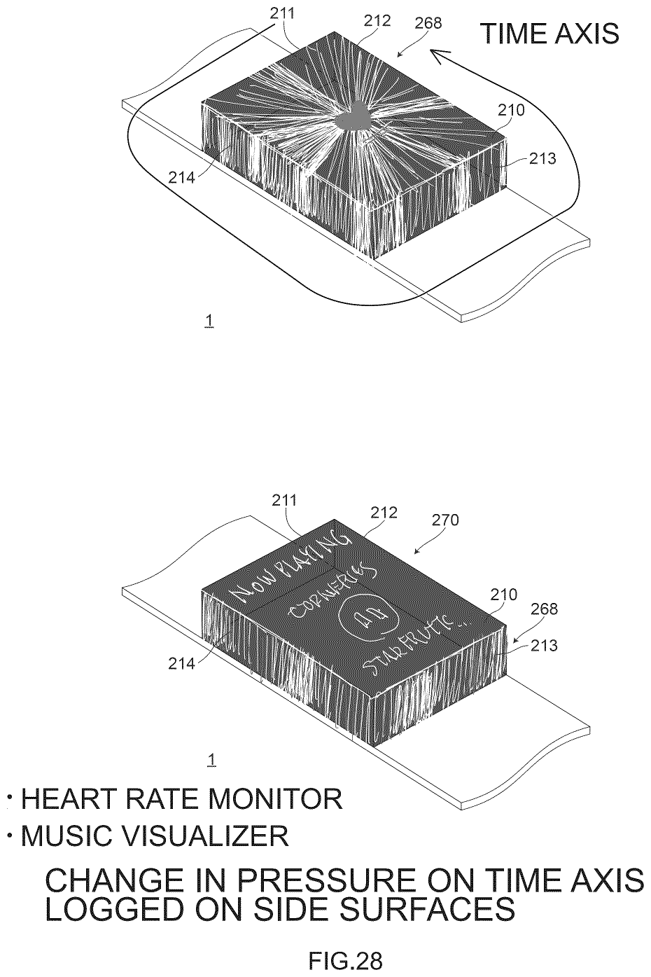

FIG. 28 is a view for describing another display mode (nineteenth display mode) of the wristwatch 1 according to the embodiment. The nineteenth display mode is, as illustrated in FIG. 28, a display mode where a pattern 268 that indicates a change in pressure on a time axis is displayed on the side face display units 211 to 214. The nineteenth display mode may be a display mode as a so-called heart rate monitor where, as the pattern 268 that indicates a change in pressure on a time axis, a pattern that indicates a heartbeat of a user moves on four side face display units 211 to 214 and on the upper face display units 210 in a counterclockwise direction. Further, as illustrated in a lower view of FIG. 28, the nineteenth display mode may be a display mode as a so-called music visualizer where, as the pattern that indicates a change in pressure on a time axis, a pattern that indicates a sound pressure during reproduction moves on four side face display units 211 to 214 in a counterclockwise direction, for example, and information relating to music during reproduction and an icon 270 for operating a player relating to the reproduction of music are displayed on the upper face display unit 210. In the wristwatch 1 according to the embodiment, the display control unit 450 controls the displays of the respective five display units 210 to 214 such that the above-mentioned display mode can be realized.

### [Twentieth Display Mode]

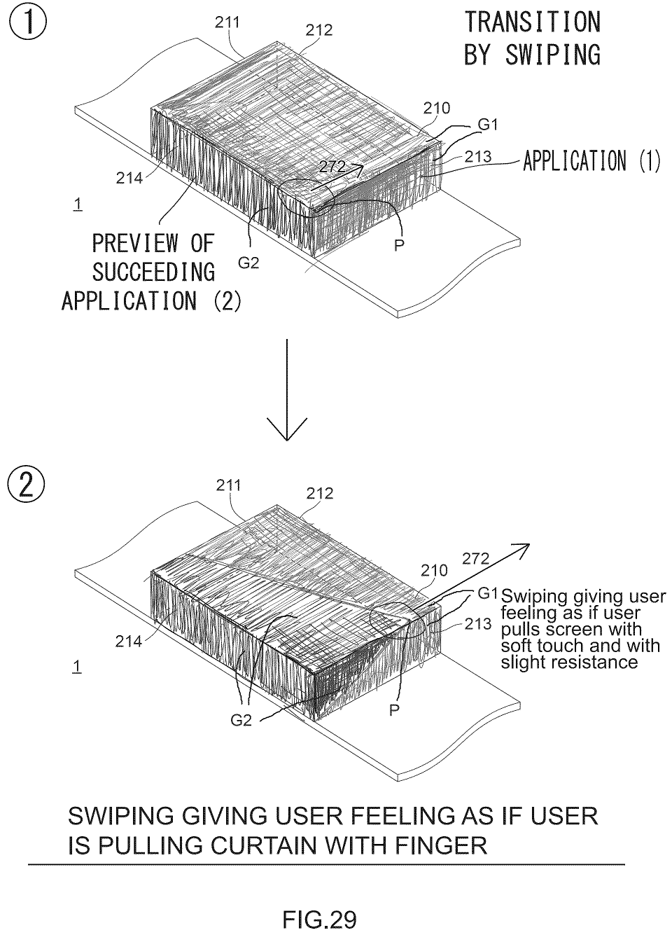

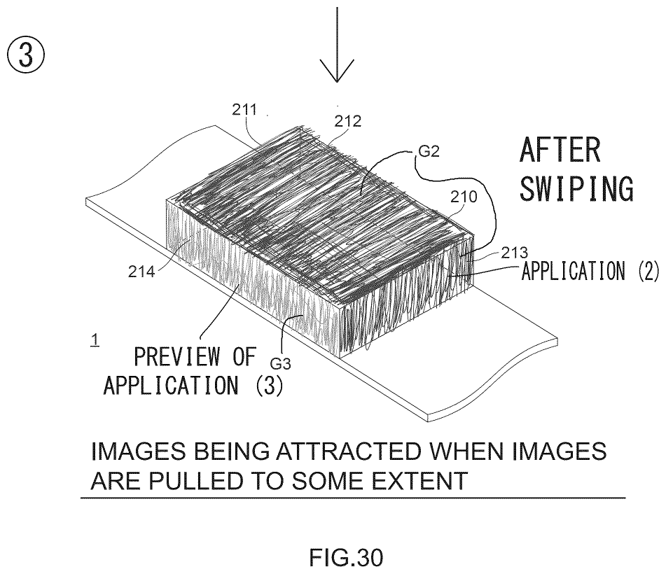

FIG. 29 and FIG. 30 are views for describing another display mode (twentieth display mode) of the wristwatch 1 according to the embodiment. The twentieth display mode is a display mode where a display is changed over by a swipe operation. For example, as illustrated in an upper view in FIG. 29, as an initial state, a first image G1 is displayed on four face display units consisting of the upper face display unit 210, the first side face display unit 211, the second side face display unit 212 and the third side face display unit 213, and second image G2 is displayed on the remaining fourth side face display unit 214. Then, as illustrated in a lower view in FIG. 29, a display is performed where, by swiping an arbitrary portion P on a boundary between the first image G1 and the second image G2 using a finger, the boundary between the first image G1 and the second image G2 and a boundary between the second image G2 and a third image G3 not illustrated in the drawing are moved by pulling. Then, the arbitrary portion P is further swiped using the finger. When the swiping operation is finished, as illustrated in FIG. 30, the display control unit 450 performs a control as if the boundary between the first image G1 and the second image G2 and the between the second image G2 and the third image G3 are stopped by being attracted by something.

As a display example where a display is changed over by a swipe operation, for example, the changeover between an analog display and a digital display, a changeover between a watch display and a calendar display, the release of locking and the like can be exemplified. However, besides these changeovers, various display changeovers can be performed. In the wristwatch 1 according to the embodiment, the display control unit 450 controls the displays of the respective five display units 210 to 214 such that the above-mentioned display mode can be realized.

To realize the twentieth display mode, as five display units 210 to 214, touch panels that are prepared by disposing a touch panel on surfaces of five respective organic EL display sheets are used. The touch pad may be disposed on a surface of the black member 280.

In the above-mentioned embodiment, the case is exemplified where the black member is embedded in the gap formed between five display units 210 to 214 (between the organic EL display sheets disposed adjacently to each other so as to make the gap inconspicuous. However, a thickness of the organic EL display sheet is thin and hence, there may be a case where the gap is not formed in a neighboring portion between the respective organic EL display sheets in a conspicuous manner. In such a case, the black member may not be embedded in the neighboring portion between the respective organic EL display sheets. Even when the black member is not embedded, it is preferable to apply by coating a protective member so as to cover the entirety of the display units and to cure the protective member thereafter.

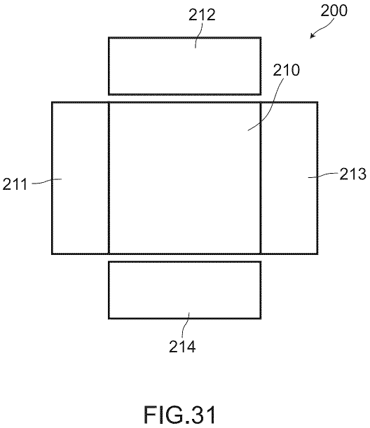

(8) In the above-mentioned embodiments, the case is exemplified where five display units 210 to 214 are formed of five organic EL display sheets (see FIG. 3B). Further, as the modifications of the above-mentioned embodiments, the case is exemplified where five display units 210 to 214 are formed of one organic EL display sheet (see FIG. 16). However, the present invention is not limited to these cases. That is, five display units 210 to 214 may be formed of two to four organic EL display sheets. For example, as illustrated in FIG. 31, five display units 210 to 214 may be formed of three organic EL display sheets. In FIG. 31, the first side face display unit 211, the upper face display unit 210 and the third side face display unit 213 are connected to each other so as to form one organic EL display sheet, and the second side face display unit 212 and the fourth side face display unit 214 are formed of two organic EL display sheets that are separated into one piece respectively. With such a configuration, five display units 210 to 214 are formed of three organic EL display sheets.

The example where five display units 210 to 214 are formed of three organic EL display sheets is not limited to the above-mentioned example. Although not illustrated in the drawings, for example, the second side face display unit 212, the upper face display unit 210 and the fourth side face display unit 214 may be connected to each other so as to form one organic EL display sheet, and the first side face display unit 211 and the third side face display unit 213 are formed of two organic EL display sheets that are separated into one piece respectively. With such a configuration, five display units 210 to 214 are formed of three organic EL display sheets.

Although not illustrated in the drawing, five display units 210 to 214 may be formed of two organic EL display sheets. For example, the first side face display unit 211 to the fourth side face display unit 214 are connected to each other so as to form one organic EL display sheet, and only the upper side face display unit 210 is formed of one separated organic EL display sheet. With such a configuration, five display portions 210 to 214 are formed of two organic EL display sheets.

Although not illustrated in the drawing, five display units 210 to 214 may be formed of four organic EL display sheets. For example, the first side face display unit 211 and the upper face display unit 210 are connected to each other so as to form one organic EL display sheet, and the second side face display unit 212, the third side face display unit 213 and the fourth side face display unit 214 are formed of three organic EL display sheets that are separated into one piece respectively. With such a configuration, five display units 210 to 214 are formed of four organic EL display sheets.

(9) In the above-mentioned embodiments, the description has been made with respect to the case where the wristwatch has five display units. However, the wristwatch may be a wristwatch that does not have five display units. That is, it is sufficient that the wristwatch according to the present invention includes: the wristwatch body 100 having a rectangular parallelepiped shape; at least two display units that are formed over the entirety of “the upper face on a side opposite to a lower side directed to an arm side of a user at the time of using the wristwatch” and “at least one side face of four side faces” respectively out of six faces that form the surface of the wristwatch body 100; and the display control unit that controls the displays of at least two respective display units. That is, in the wristwatch 1 according to the above-mentioned embodiment, at least two display units are formed of five display units formed over the entirety of the five respective faces formed of the upper face and four side faces. However, it is sufficient that the wristwatch 1 has at least two display units instead of five display units.

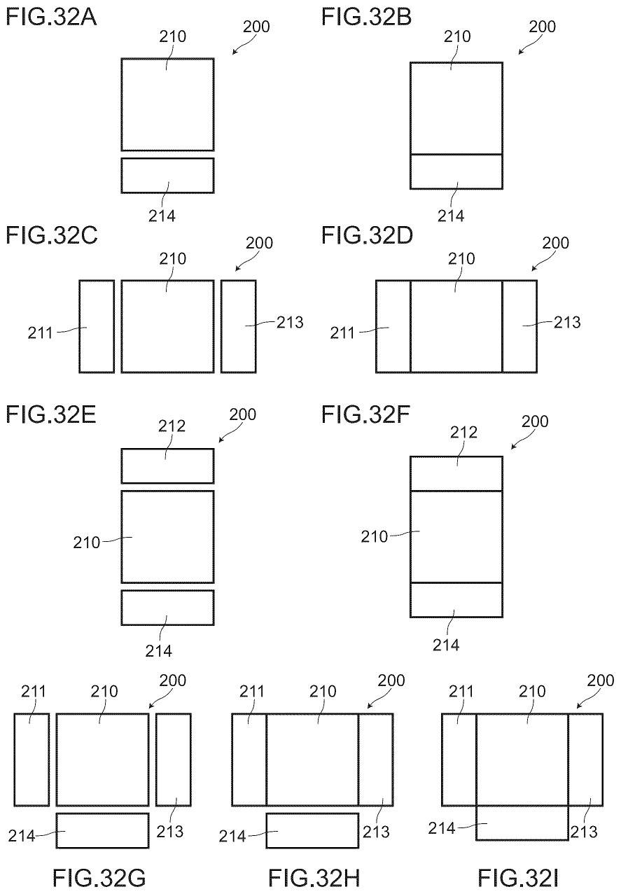

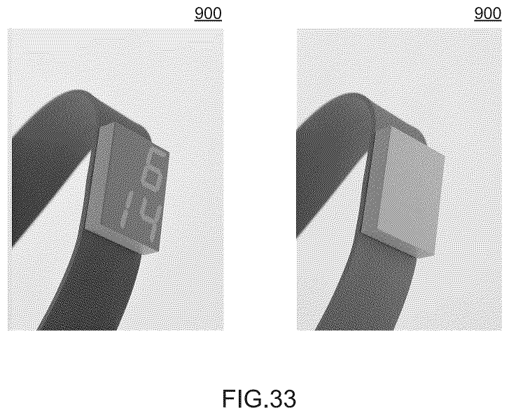

FIG. 32A to FIG. 321 are views illustrating one example of the case where the display unit 20 is formed of at least two display units. In FIG. 32A to FIG. 321, as at least two display units, the display units 200 of the wristwatch each having two to four display units are illustrated in a developed form. In FIG. 32A to FIG. 321, FIG. 32A and FIG. 32B illustrate cases where the wristwatch has two display units. FIG. 32C to FIG. 32F illustrate cases where the wristwatch has three display units. FIG. 32G to FIG. 321 illustrate cases where the wristwatch has four display units. As illustrated in the respective views in FIG. 32A to FIG. 321, in the wristwatch having two to four display units, there exist faces that do not have a display unit formed of an organic EL display sheet. However, the protective member may be applied by coating also to the faces that do not have the display unit formed of the organic EL display sheet and are cured thereafter.

Further, as illustrated in the respective views in FIG. 32A to FIG. 321, also in the case where the wristwatch has two to four display units, each respective display unit may be formed of a plurality of organic EL display sheets or may be formed of one organic EL display sheet. That is, FIG. 32A and FIG. 32H illustrate the case where each display unit is formed of two organic EL display sheets. FIG. 32C and FIG. 32E illustrate the case where each display unit is formed of three organic EL display sheets. FIG. 32G illustrate the case where each display unit is formed of four organic EL display sheets. FIG. 32B, FIG. 32D, FIG. 32F and FIG. 32I illustrate the case where each display unit is formed of one organic EL display sheet.

In FIG. 31 and FIG. 32A to FIG. 321, there are cases where the upper face display unit 210 has a square shape. However, as illustrated in FIG. 3A to FIG. 3C used in the above-mentioned description of the embodiment, the upper face display unit 210 may have a rectangular shape. On the other hand, although the upper face display unit 210 has a rectangular shape in the above-mentioned embodiment, the upper face display unit 210 may have a square shape.

(10) In the above-mentioned embodiment, the case is exemplified where the display unit 200 (five display units 210 to 214) is formed of the organic EL display sheets. However, the display unit 200 (five display units 210 to 214) may be formed of micro light emitting diode (LED) display sheets.

(11) In the above-mentioned embodiment, the description has been made with respect to the case where the present invention is directed to the wristwatch 1. However, the present invention is also directed to a wristwatch type display device. Also in the case where the present invention is directed to the wristwatch type display device, the wristwatch type display device includes: a wristwatch type display device body 100 having a rectangular parallelepiped shape; at least two display units that are formed over the entirety of “an upper face on a side opposite to a lower face directed to an arm side of a user at the time of using the wristwatch type display device” and “at least one side face of four side faces” respectively out of six faces that form a surface of the wristwatch type display device body; and a display control unit that controls the displays of at least two respective display units. Further, it is preferable that the display control unit has a function of controlling display on each of the at least two display units such that images displayed on the respective at least two display units are moved in a linked manner or are associated with each other. In such a wristwatch type display device, it is preferable that at least two display units be five display units that are formed over the entirety of the respective five faces formed of an upper face and four side faces. In such a wristwatch type display device, a display control that a display control unit 450 performs may be set such that a display control peculiar to the wristwatch type display device that the wristwatch does not particularly require is performed.

As has been described heretofore, according to the wristwatch type display device of the present invention, various images can be displayed in various modes by making use of also the side faces in addition to the upper face of the wristwatch type display device body having a rectangular parallelepiped shape. As a result, according to the wristwatch type display device of the present invention, it is possible to provide a wristwatch type display device having a new value not obtained by the prior art. The wristwatch type display device according to the present invention can be carried out in modified modes in the same manner as the wristwatch according to the present invention.

1. A wristwatch comprising:
a wristwatch body having a rectangular parallelepiped shape;
at least two display units that are formed over respective entire areas of “an upper face on a side opposite to a lower face directed toward a side of an arm of a user at a time of using the wristwatch” and “at least one side face out of four side faces” out of six faces that form a surface of the wristwatch body; and
a display control unit configured to control a display of each of the at least two display units,
wherein the display control unit has a function of controlling display on each of the at least two display units such that images displayed on the respective at least two display units are moved in a linked manner.

2. The wristwatch according to claim 1, wherein the display control unit has a function of controlling display on each of the at least two display units such that the images displayed on the at least two display units move in a seamless manner by straddling the at least two display units.

3. The wristwatch according to claim 1, wherein at least two display units include: five display units that are formed over the respective entire areas of five faces that are formed of the upper face and the four side faces.

4. The wristwatch according to claim 3, wherein in a state where the five faces of the wristwatch body display no pattern on the five display units, no pattern is displayed over the entire areas of five respective display units.

5. The wristwatch according to claim 3, wherein the five display units are formed of five organic EL display sheets or five micro LED display sheets, and
the five organic EL display sheets or the micro LED display sheets are laminated to the five faces of the wristwatch body respectively.

6. The wristwatch according to claim 3, wherein the five display units are formed of one organic EL display sheet or one micro LED display sheet, and
the one organic EL display sheet or one sheet of micro LED display sheet is bent along an outer shape of the wristwatch body and is attached to the wristwatch body.

7. The wristwatch according to claim 5, wherein a first electrode group for supplying power and electric signals to the organic EL display sheet or the micro LED display sheet is mounted on the five faces of the wristwatch body, and
a second electrode group for receiving the power and the electric signals from the first electrode group are mounted on a back face of the organic EL display sheet or the micro LED display sheet at a position that corresponds to the first electrode group, and the wristwatch includes a drive circuit that supplies an electric signal for controlling a turn on/off states of the respective pixels of the organic EL display sheet or the micro LED display sheet, and
the first electrode group and the second electrode group are electrically connected to each other.

8. The wristwatch according to claim 3, wherein a gap formed between five display units is embedded with a black member so as to prevent the gap from being visually recognized from the outside.

9. The wristwatch according to claim 3, wherein a protective member is applied to by coating to five display units so as to cover the entirety of five display units and is cured.

10. The wristwatch according to claim 3, wherein assuming the display unit formed on an upper face of the wristwatch body on a side opposite to a lower face of the wristwatch body as an upper face display unit and the display units formed on four side faces of the wristwatch body as four side face display units with respect to the five display units,
in a case where a display mode on the five display units is an analog watch display mode where a time is displayed by a plurality of hands, the display control unit controls the respective displays of the five display units such that at least the longest hand out of the plurality of hands extends from the upper face display unit to at least one side face display unit out of the four side face display units, and a portion of the hand that extends over the one side face display unit that is displayed on the upper face display unit and a portion of the hand that extends over the first side face display unit that is displayed on the one side face display unit rotate in a linked manner.

11. The wristwatch according to claim 3, wherein assuming the display unit formed on an upper face of the wristwatch body on a side opposite to a lower face of the wristwatch body as an upper face display unit and display units formed on four side faces of the wristwatch body as four side face display units with respect to the five display units, and assuming the side face display unit positioned on a depth side as viewed from a user at a time of using the wristwatch as a first side face display unit, the side face display unit positioned on a back side of a hand as a second side face display unit, the side face display unit disposed on a side opposite to the first side face display unit as a third side face display unit, and the side face display unit disposed on a side opposite to the second side face display unit as a fourth side face display unit with respect to the four side face display units,
in a case where a display mode in the five display units is in an analogue watch display mode where time is indicated by a plurality of hands, the display control unit controls the respective displays of the five display units such that the inside of the wristwatch body is viewed as if in a see-through manner as viewed from the user, and a display of numerical values that indicates a time in the analogue watch display mode is performed in a left-and-right normal display on at least the third side face display unit, and is performed in a reverse left-and-right display in at least the first side face display unit.

12. The wristwatch according to claim 3, wherein in a case where a display mode in the five display units is in an analogue watch display mode where time is indicated by a plurality of hands, the display control unit controls the respective displays of the five display units such that the inside of the wristwatch body is viewed as if in a see-through manner as viewed from the user at a time of using the wristwatch, and the plurality of hands rotate in a state where the plurality of hands are positioned in the wristwatch body.

13. The wristwatch according to claim 3, wherein the display control unit controls the respective displays of the five display units as if the inside of the wristwatch body is viewed in a see-through manner as viewed from a user.

14. The wristwatch according to claim 3, wherein assuming the display unit formed on an upper face opposite to a lower face of the wristwatch body as an upper face display unit with respect to the five display units and display units formed on four side faces of the wristwatch body as four side face display units,
in a case where the display mode adopted by the five display units is a digital watch display mode where a time is displayed as a combination of a plurality of numerals, the display control unit performs a control where at least a portion of the plurality of numerals extends from the upper face display unit over the four side face display units or a portion that has been extended once returns to the upper face display unit.

15. The wristwatch according to claim 3, wherein the five display units is formed of a touch panel.

16. The wristwatch according to claim 15, wherein the display control unit controls the respective displays of the five display units such that an image is changed over corresponding to a swipe operation performed by a finger of the user on the touch panel.

17. A wristwatch type display device comprising:
a wristwatch type display device body having a rectangular parallelepiped shape;
at least two display units that are formed over respective entire areas of “an upper face on a side opposite to a lower face directed to an arm side of a user at a time of using the wristwatch type display device” and “at least one side face out of four side faces” out of six faces that form a surface of the wristwatch type display device body; and
a display control unit that controls the respective displays of the at least two display units,
wherein the display control unit has a function of controlling display on each of the at least two display units such that images displayed on the respective at least two display units are moved in a linked manner.

18. The wristwatch type display device according to claim 17, wherein the display control unit has a function of controlling display on each of the at least two display units such that the images displayed on the at least two display units move in a seamless manner by straddling the at least two display units.

19. The wristwatch type display device according to claim 17, wherein the at least two display units are formed of five display units that are formed over the respective entire areas of five faces formed of the upper face and the four side faces.

20. The wristwatch according to claim 6, wherein a first electrode group for supplying power and electric signals to the organic EL display sheet or the micro LED display sheet is mounted on the five faces of the wristwatch body, and
a second electrode group for receiving the power and the electric signals from the first electrode group are mounted on a back face of the organic EL display sheet or the micro LED display sheet at a position that corresponds to the first electrode group, and the wristwatch includes a drive circuit that supplies an electric signal for controlling a turn on/off states of the respective pixels of the organic EL display sheet or the micro LED display sheet, and
the first electrode group and the second electrode group are electrically connected to each other.
